(19) United States
(12) Patent Application Publication
(10) Pub. No.: US 2014/0310349 A1
(43) Pub. Date: Oct. 16, 2014

(54) METHOD AND APPARATUS FOR ESTABLISHING RELATIONSHIPS AMONG DEVICES AND USERS

(71) Applicant: NOKIA CORPORATION, Espoo (FI)

(72) Inventor: Roope Aleksi Rainisto, Helsinki (FI)

(73) Assignee: Nokia Corporation, Espoo (FI)

(21) Appl. No.: 13/862,050

(22) Filed: Apr. 12, 2013

(51) Int. Cl. H04L 29/06

(52) U.S. Cl. CPC H04L 65/403
USPC 709/204

(57) ABSTRACT

An example approach is provided for establishing relationships among devices and users. A token sharing platform causes, at least in part, a selection of at least one token at a first device associated with a first user based, at least in part, on initiating a request to establish and/or modify a record indicating a relationship between the first user and at least one second user. By way of example, the at least one token represents the at least one second user at the first device. The token sharing platform then causes, at least in part, a transmission of the at least one token to at least one second device, wherein the at least one second device is associated with the at least one second user and the at least one token represents the first user at the at least one second device.

### BACKGROUND

Wireless (e.g., cellular) service providers and device manufacturers are continually challenged to deliver value and convenience to consumers by, for example, providing compelling network services, applications, and content. One area of focus has been the development of services and applications to facilitate relationship building or connecting among users (e.g., social networking services). However, as these types of services proliferate and a greater number of relationships and connections proliferate among users, each user may face the problem of lack of personalization to uniquely identify or represent the relationships. As a result, service providers and device manufacturers face significant technical challenges to enable users to memorialize or otherwise represent relationships that they create, i.e., with unique tokens such as photographs, videos or other media items.

### SOME EXAMPLE EMBODIMENTS

Therefore, there is a need at least for an approach for establishing relationships among devices and users.

According to one embodiment, a method comprises causing, at least in part, a selection of at least one token at a first device associated with a first user based, at least in part, on initiating a request to establish and/or modify a record indicating a relationship between the first user and at least one second user. The at least one token represents the at least one second user at the first device. The method further comprises causing, at least in part, a transmission of the at least one token to at least one second device. The at least one second device is associated with the at least one second user and the at least one token represents the first user at the at least one second device.

According to another embodiment, an apparatus comprises at least one processor, and at least one memory including computer program code for one or more computer programs, the at least one memory and the computer program code configured to, with the at least one processor, cause, at least in part, the apparatus to select at least one token at a first device associated with a first user based, at least in part, on initiating a request to establish and/or modify a record indicating a relationship between the first user and at least one second user. The at least one token represents the at least one second user at the first device. The apparatus is further caused to transmit the at least one token to at least one second device, wherein the at least one second device is associated with the at least one second user and the at least one token represents the first user at the at least one second device.

According to another embodiment, a computer-readable storage medium carrying one or more sequences of one or more instructions which, when executed by one or more processors, cause, at least in part, an apparatus to select at least one token at a first device associated with a first user based, at least in part, on initiating a request to establish and/or modify a record indicating a relationship between the first user and at least one second user. The at least one token represents the at least one second user at the first device. The apparatus is further caused to transmit the at least one token to at least one second device. The at least one second device is associated with the at least one second user and the at least one token represents the first user at the at least one second device.

According to another embodiment, an apparatus comprises means for causing, at least in part, a selection of at least one token at a first device associated with a first user based, at least in part, on initiating a request to establish and/or modify a record indicating a relationship between the first user and at least one second user. The at least one token represents the at least one second user at the first device. The apparatus further comprises means for causing, at least in part, a transmission of the at least one token to at least one second device. The at least one second device is associated with the at least one second user and the at least one token represents the first user at the at least one second device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a communication system capable of establishing relationships among devices and users, according to one embodiment;

FIG. 1B is a diagram of a the components of a token sharing platform, according to one embodiment;

FIG. 2A is a diagram of the components of a wireless node including an awareness services module, according to an embodiment;

FIGS. 2B-2E are diagrams of the components of an awareness services module, according to various embodiments;

FIG. 2F is a diagram of the data structure of a network layer message header, according to an exemplary embodiment;

FIG. 2G is a diagram depicting a power saving scheme of a device-to-device radio layer, according to an embodiment;

FIGS. 3A-3D are flowcharts of processes for locating communities and community members over an ad hoc network, according to various embodiments;

FIG. 4 is a flowchart of a process for detecting proximate devices for establishing relationships among devices and users, according to one embodiment;

FIG. 5A is a ladder diagram that illustrates a sequence of messages and processes used in a querying node, according to an embodiment;

FIG. 5B is a ladder diagram that illustrates a sequence of messages and processes used in a replying node, according to an embodiment;

FIGS. 6 and 7 illustrate flowcharts of processes for establishing relationships among devices and users, according to various embodiments;

FIG. 8 is a ladder diagram that illustrates sequences of messages and processes used in establishing relationships among devices and users via an ad hoc network, according to an embodiment;

FIGS. 9A through 9D are diagrams of a user interface utilized in the processes of establishing relationships among devices and users via an ad hoc network, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF PREFERRED EMBODIMENT

Examples of a method, apparatus, and computer program for establishing relationships among devices and users are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices may be shown in block diagram form in order to avoid unnecessarily obscuring the embodiments of the invention.

As used herein, the term “awareness information” refers to any content, information and/or context about a local environment as well as the users and communication devices within the local environment. By way of example, awareness information can be used to support applications for creating social networks, sharing relationship tokens (e.g., a digital object, file, content, etc., that represents one or more users and/or their relationships), determining presence, determining contexts associated with a device, advertising, searching for information, etc. Although various embodiments are described with respect to communities over an ad hoc mesh network, it is contemplated that the approach described herein may be used within any type of communication system or wireless network. Further, a “wireless node” or a “node” may be any device and/or user equipment (UE) capable of wireless communication with other devices and/or user equipment directly and/or via one or more available wireless networks.

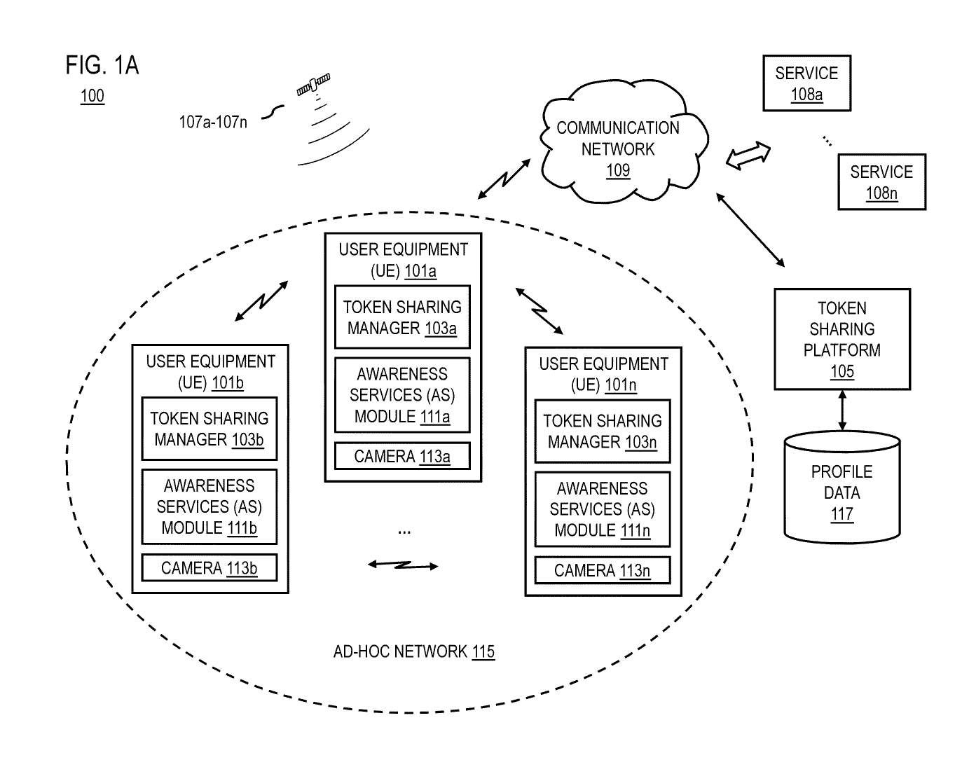

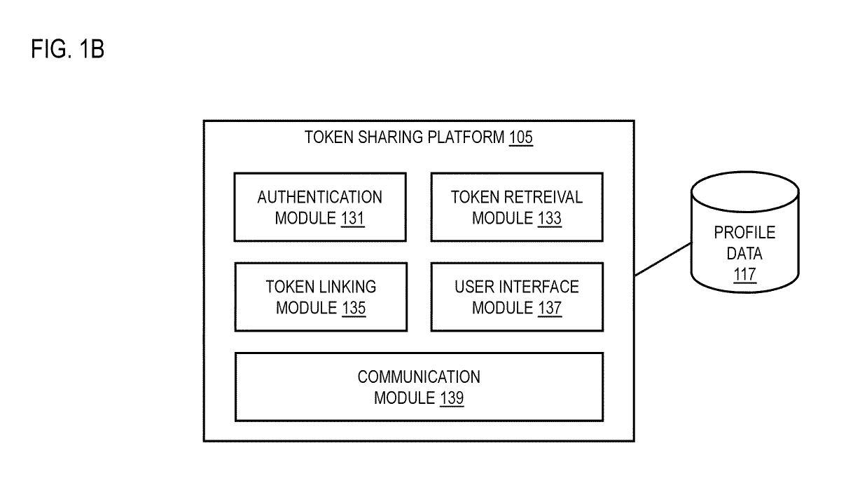

FIG. 1 is a diagram of a communication system capable of establishing relationships among devices and users, according to one embodiment. As noted above, with the proliferation of social networking services and applications, devices (e.g., mobile devices) offer various ways for users to network with each other. For example, a traditional contact management or social networking service traditionally offers the possibility for people to create contact cards for each other. These contact cards typically contain contact details for a particular person in, for instance, database fields. In addition, users generally are also able to add personalized notes and other media regarding the contact (e.g., an avatar picture or other media item such as a ringtone representing the person). However, adding such personalization (e.g., adding a picture that was meaningful or had a special meaning to the user and the contact only) can be burdensome and complex as this may require too many steps. As a result, many users often avoid using the personalization features traditionally included in contact applications and other similar applications.

In addition to contact-type applications, social network services and applications typically allow users to “formalize” their relationship status with other users. This may include, for example, identifying one or more other members of the social networking service as friends, followers, etc. Unfortunately, there is currently no convenient means of synchronizing the relationship status of associated users based on said personalized, common media (e.g., pictures).

To address at least this issue, the system of FIG. 1A presents a token sharing platform 105 that is configured to enable the collecting and subsequent sharing of tokens between users of user equipment (UE) 101a-101n. The sharing procedure performed by the token sharing platform 105 is based on a determined association, link or commonality between the users by way of a social networking service, contact management service or application, shared media service or application, or the like. The above described services 108a-108n (referred to herein collectively as services 108) may be accessed by a UE 101a-101n by way of a communication network 109.

For example, a user may update or create a social networking record via their social networking service 108 for indicating a relationship status with another user of the social networking service 108. As another example, a user of UE 101a-101n (referred to herein collectively as UE 101) may invoke a contact record (e.g., a contact card) via a contact management application at the device for storing details regarding another user. For the purpose of illustration herein, a record may pertain to any set of data and data types for representing a user, a group of users, an entity or the like. In either case, the token sharing platform 105 may operate in connection with the UE 101 by way of a token sharing manager 103a-103n. The token sharing manager 103a-103n may be active—i.e., running as a background executable process—as the UE 101 executes the social networking service 108 or application to determine said relationship status.

In one embodiment, the token sharing platform 105 interacts with respective UE 101a-101n (referred to herein collectively as UE 101) by way of the token sharing manager 103a-103b (referred to herein collectively as token sharing managers 103). The token sharing manager 103 may be implemented as an executable module, application programming interface (API) or the like for interfacing with a social networking service 108, contact management utility or other application of the UE 101. As such, when a first UE 101a initiates a request to establish and/or modify a record related to a user of a second UE 101b, the token sharing manager 103 alerts the token sharing platform 105 accordingly. This activation may include, for example, initiating a request to share a token as captured via a camera 113a or any other data capture mechanism of the first UE 101a with a user of the second UE 101b.

For the purpose of illustration, the token may include any type of data expressly intended to represent, depict or denote the user of the second UE 101b, the type of relationship between the user of the second UE 101b, a common group affiliation, a common experience, or a combination thereof. This may include, for example, an image of the various users in common, a certain posture/expression/pose of a user, tactile and smell effects, sound information, or any other representation. As mentioned above, acquisition and/or generation of a token as it relates to a record may include the direct capture of a token via a data capture mechanism of the UE 101, a selection of previously captured data from a data store of the UE 101, or a combination thereof. Hence, the tokens to be generated and/or acquired per said data capture mechanisms may include not only an image, but a video, an audio sample, tactile data, or a combination thereof related in common to the different users of the different UE 101a and 101n (e.g., a picture featuring both users). Still further, the commonality may be based on a linking or matching of the record (for which the token is generated and/or acquired) with another record set maintained by the social networking service 108, contact management application, etc.

In one embodiment, the token sharing manager 103 may also be configured to operate in connection with the camera 113a or other data capture mechanism of respective UE 101. By way of example, the token sharing manager 103 determines user activation of the camera 113 for capturing a token (image) in association with a record. In addition, the token sharing manager 103 determines user acceptance of the acquired and/or generated token. The acceptance may correspond to an acknowledgement by the user of a first UE 101a that a captured image appropriately depicts a relationship or commonality between the user of the first UE 101a and a user of a second UE 101b. Still further, the acceptance may correspond to a procedure executed per the token sharing platform 105 for initiating the generating or updating of such a token with respect to a record for associating the respective users via the social networking service, contact management service, or other service 108.

It is noted that the token sharing manager 103 may operate in connection with a service 108 to accommodate different token generation (e.g., first time generation) and/or acquisition (e.g., acquisition of an existing token) scenarios. This process may be based, at least in part, on whether a record for indicating the relationship exists or not. For example, in the case where no relationship exists between users, a relationship may be established via a social networking service or other service 108. As such, the token sharing manager 103 enables the relationship to be formulated based on an established record (of at least one of the users). A token for representing said newly established relationship is then generated based on the established record.

As another example where no relationship exists between users, the token sharing manager 103 enables a record to be formulated concurrent with the establishing of a relationship via the service 108. Alternatively, the record is generated afterwards. Resultantly, the token for representing the relationship may be generated concurrent with the establishing of the relationship via the service 108 or afterwards.

As yet another example, in the case where a relationship already exists between users of different UE 101a-101n and a common record exists, the token sharing manager 103 may enable respective users of UE 101a-101n to decide to create a record or rely upon an existing record of the common relationship. Consequently, the token sharing manager 103 enables formation of one or more new tokens or usage of existing token for representing the relationship.

It is noted that the token sharing manager 103 may detect activation of a sound recorder, light recorder, motion/pattern detector, olfactory sensor or other data capture mechanism of the UE 101 in connection with the creating or updating of a record. Still further, the manager 103 may further detect the selection of a button, switch, or any other mechanism for triggering the data capture mechanism of the UE 101 whether physical, software based, sense activated or a combination thereof.

In one embodiment, the token sharing platform 105 receives the token acquired and/or generated at the UE 101 and subsequently transmits the token to the other UE to which the record pertains. By way of example, the transmission may include the submission of the token to a common social networking service 108 of the user of the other UE. Under this scenario, the token is uploaded to the database of the social networking service 108 in connection with the profile of the second user. As such, the token is automatically rendered to the user interface of the second user when said user accesses the social networking service 108 to lookup or invoke a record of the first user. Alternatively, the transmission may include direct loading of the token at the UE 101, wherein the token is automatically invoked in response to accessing of a record for said first user via the UE 101. Still further, the token may add itself in the user interface of the UE as a ‘shortcut’ for facilitating user access of the associated record, social networking service, or any other associated communications ‘channel’ that connects the users. Under this scenario, if a shortcut for contact information of that user exists, the token may replace it or complement it.

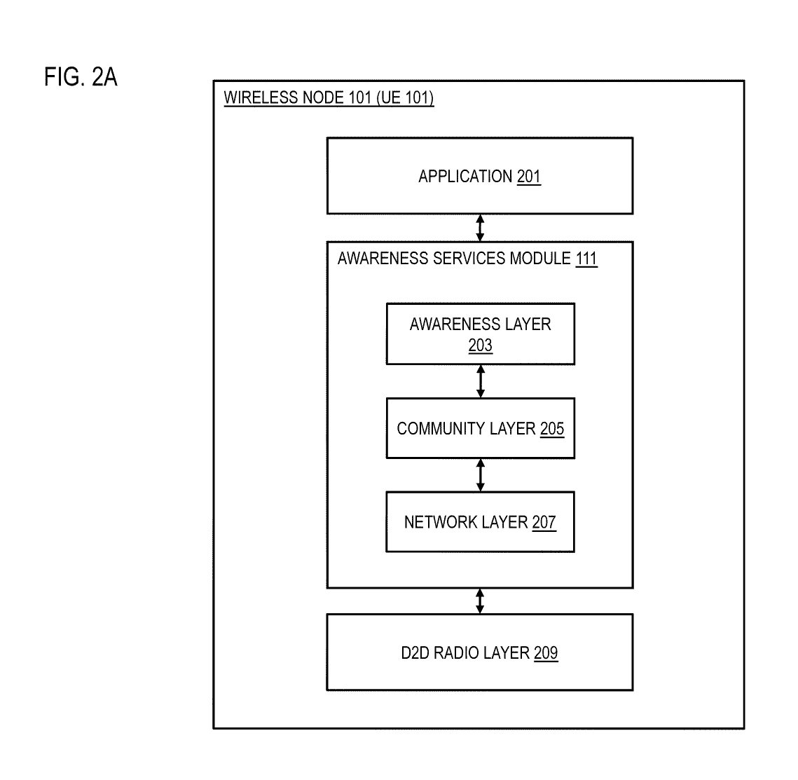

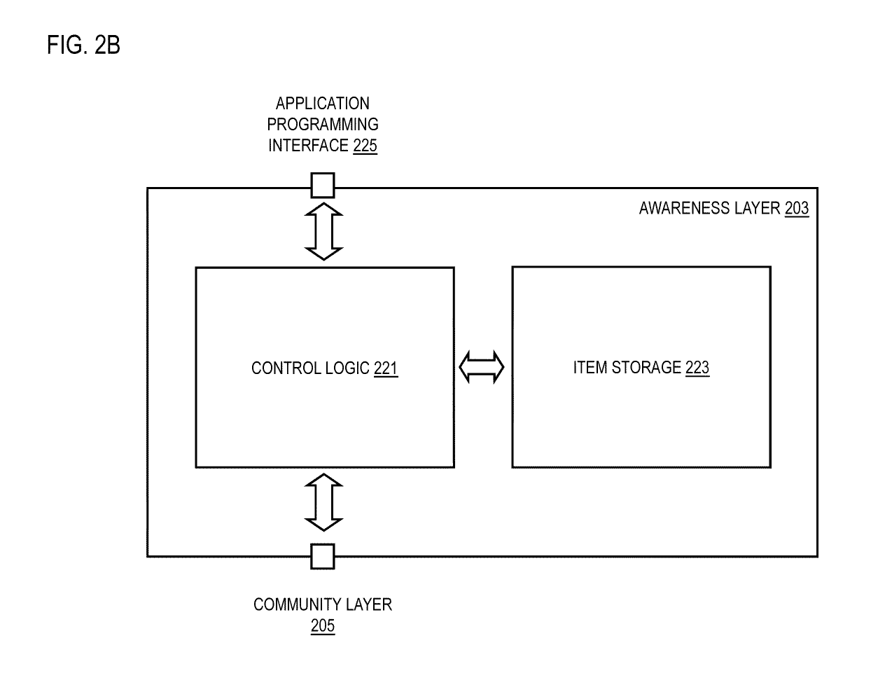

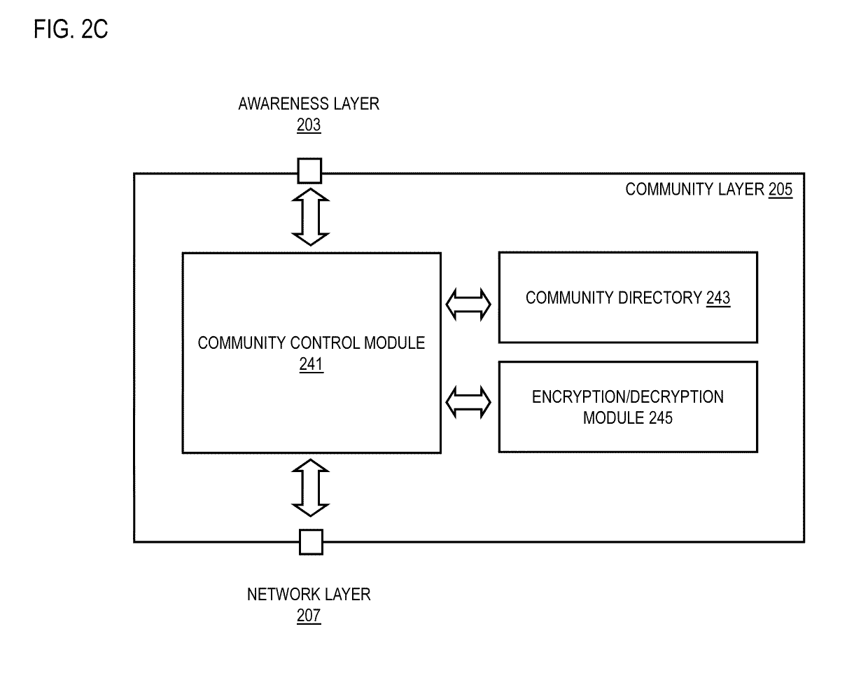

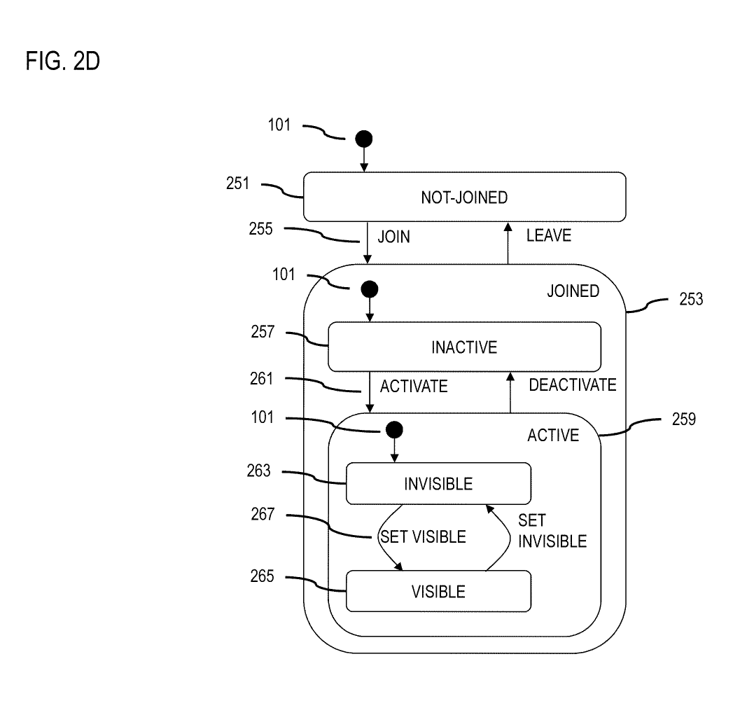

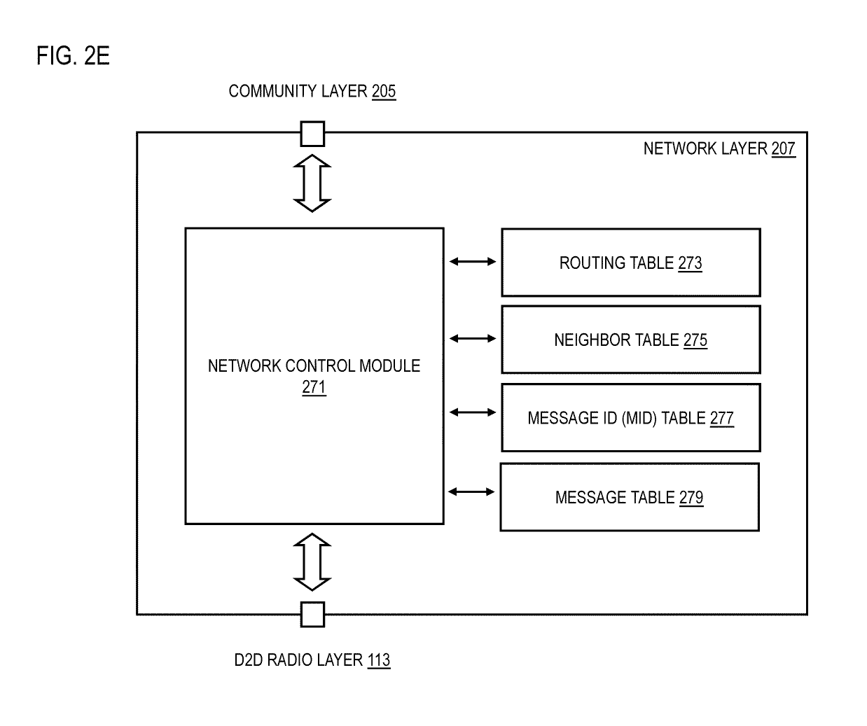

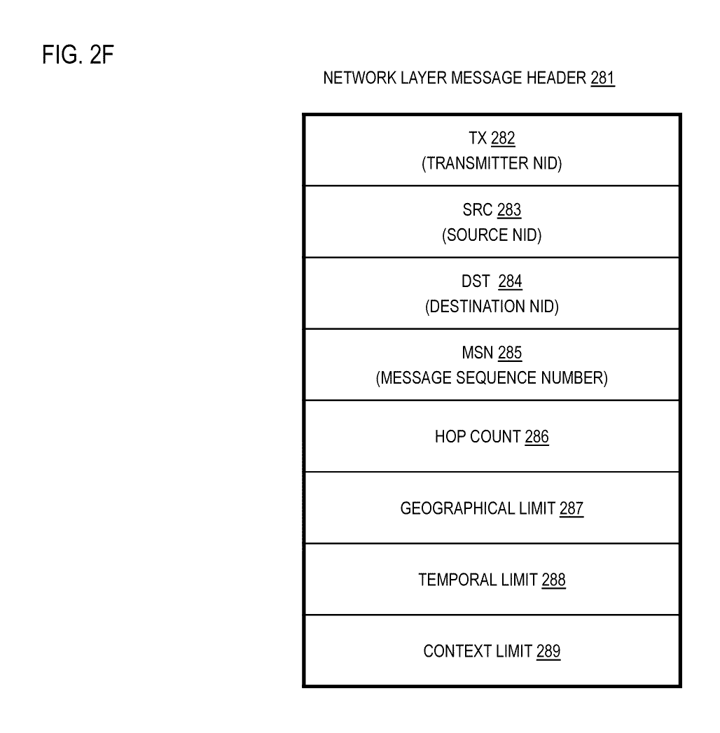

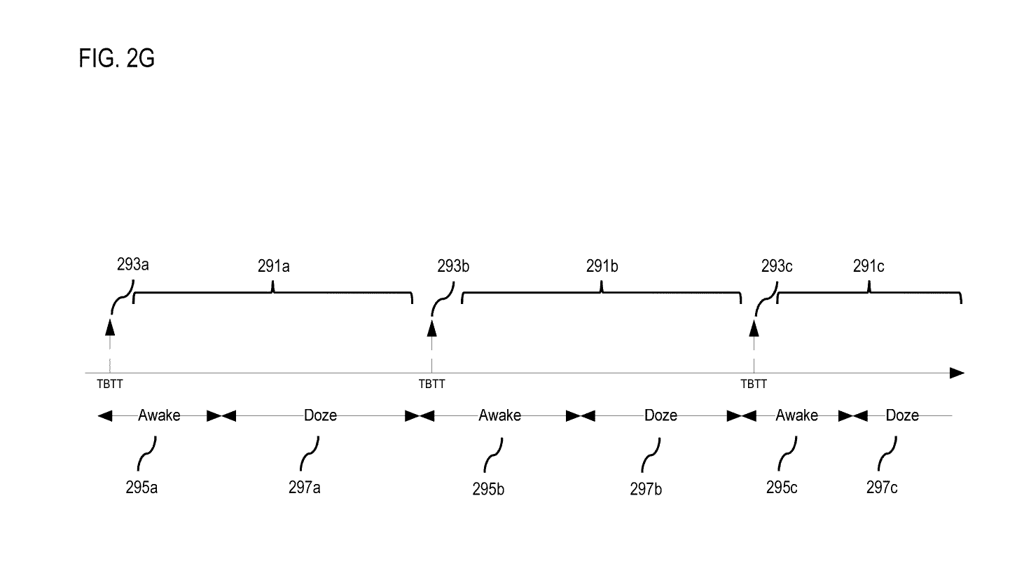

Although various embodiments described herein are discussed with respect to establishing communications among the UEs 101 via a peer-to-peer ad hoc mesh network, it is contemplated that the system 100 may use any communication means for enabling the exchange of data over a network, i.e., communication network 109, by multiple devices via a communication protocol. As discussed below with respect to FIGS. 2A-5B, an ad hoc mesh network may be implemented for enabling the exchange of tokens among UE 101 in connection with the token sharing platform 105.

By way of example, the token sharing platform 105 may be implemented as a network/hosted service of the user of given UE 101. Under this scenario, the user may subscribe with a provider of the token sharing platform 105 according to a subscription agreement; which may include the entry of profile data 117. Alternatively, the user may initiate the subscription by way of direct subscription with a social networking service or other service 108 for maintaining data regarding various contacts associated with the user of the UE 101. The agreement may include a specification of the UE 101, an activation of the token sharing manager 103, or the like for supporting user access to the platform 111 via a communication network 109.

Alternatively, the token sharing platform 105 may be implemented as a direct executable of the UE 101, thus enabling direct signal inputs for facilitating the capture and subsequent sharing of tokens (for facilitating a relationship between respective users and/or UE). Under this scenario, therefore, the token sharing platform 105 may be synonymous with the token sharing manager 103 in certain embodiments. It is noted that the exemplary embodiments described herein may pertain to either implementation.

The tokens as acquired or generated may be exchanged between respective UE 101 in various ways. Hence, the means of transmission of said token(s) may be performed based on one or more known wireless, short-range, or proximity based protocols and procedures. Any means for facilitating the sharing of a common token with different UE 101 is within the scope of the embodiments described herein. For the purpose of illustration herein, the foregoing paragraphs present a means of sharing of said tokens via an ad hoc networking scheme.

In one embodiment, to enable communications over an ad hoc networking scheme, the UEs 101 may include an awareness services module 111a-111n (also collectively referred to as AS module 111) for detecting and/or forming an ad hoc network 115 for sharing tokens with other UEs 101 configured to the token sharing platform 105. By way of example, the ad hoc network 115 may be implemented as a connectionless and serverless device-to-device network (e.g., a mobile ad hoc network (MANET)) created using short-range radio technology (e.g., wireless local area network (WLAN), Bluetooth®, etc.). Within the ad hoc network 115, each UE 101 may be mobile and within communication range of any number of other UEs 101. Accordingly, the set of UEs 101 which may be within communication range of any other UEs 101 is transient and can change as the UEs 101 move from location to location and/or in and out of the communication range. In one embodiment, a user may connect to or disconnect from the ad hoc network 115 on demand. It is noted that the awareness services module 111 may generate awareness information—i.e., for enabling presence detection—to support the transmission of shared tokens among UE 101.

As used herein, the term “connectionless” refers to the ability of a node (e.g. a UE 101) to send to and receive from all surrounding nodes (e.g., other UEs 101) awareness information without the need to send any prior control signaling. Once a connection is established per said awareness information, the acquired and/or generated tokens may further be shared in a connectionless fashion. For example, sending information using the transmission control protocol/IP (TCP/IP) over a WLAN ad hoc is not connectionless because of the two-way TCP control signaling between the sending and receiving nodes used to establish the TCP connection. The awareness information is provided, for instance, in small anonymous messages that are exchanged by the UEs 101 automatically without or with minimal user setup and/or intervention.

With respect to the ad hoc network, content may be broadcast via the messages among the between UEs 101. Further, the messages may also contain pointers to the tokens to be shared upon request or a small amount of data (e.g. presence or context information) to minimize the data traffic transported over the ad hoc network 115. The UEs 101 may then access the token using other communication channels (e.g., via IP through the communication network 109). Similarly, the system 100 creates routing information only when needed to route replies to queries back to the querying UE. The routing information is generated by using the query messages alone (i.e. no control signaling is used for creating routing information). After the query and subsequent reply process is completed, the routes are forgotten. In other words, the query/reply process of system 100 provisions routes for a reply to provide awareness information on demand rather than pushing awareness information from one UE 101 to another. In various embodiments, both push (e.g., information is published over the ad hoc network 115) and pull (e.g., information is queried from other UEs 101 of the ad hoc network 115) modes of disseminating awareness information are possible. In certain embodiments, it is contemplated that the pull mode of operation can be used instead of the push mode to help suppress potential spam messages.

Moreover, the system 100 optimizes the power consumption of UEs 101 communicating over the ad hoc network 115 to enable always-on operation without seriously affecting the battery life of the UEs 101. For instance, by utilizing only short awareness messages, by eliminating the need for any route maintenance signaling, by employing procedures to minimize transmission and reception of duplicative messages and by enabling an efficient sleep scheme for the short-range device-to-device radio used within each UE 101 (allowed by the low latency requirements typical of an awareness information network), the system 100 can potentially provide hundreds of hours (e.g., over 400 hours) of continuous operation of each UE 101 between battery charges in a mobile device. The system 100 could be seen as a “nervous system” between the mobile devices, where small messages (“nerve impulses”) are continuously exchanged by the mobile devices (“neurons”) in order to bring awareness to the user of a mobile device about the user's surroundings (e.g., content, information, status, token availability, etc.)

In various embodiments, users may realize advantages and benefits of the system 100 when sharing awareness information via an ad hoc network with an easy device discovery and sharing process. For example, a user has a token (e.g., picture) they would like to share with neighboring users over the ad hoc network 115. Under this scenario, the token may be generated in response to a befriending event between different users of UE 101 within the network 115 via a social networking service 108.

In one embodiment, the transmission of the one or more tokens is based, at least in part, on geo-location, contextual information, or a combination thereof associated with the one or more other devices. For example, an ad hoc message may indicate that the token may be broadcast within a certain geo-location (e.g., range), or by UEs 101 including certain contextual information associated with the UE 101 and/or a user of the UE 101, and the like. In one embodiment, the at least one token is available for sharing in substantially real-time. In one example, a user sharing a token may indicate a short duration wherein the token may be available for sharing. In one embodiment, one or more parameters of the ad hoc network may allow for tokens to be available for sharing for a certain period of time, for example, to avoid aggregated content on the network which can result higher traffic and power consumption by all devices.

In one embodiment, the system 100 determines one or more sharing rules associated with the at least one token. In one embodiment, the AS module 111 may determine one or more sharing rules, for example, from the UE 101 user preferences, metadata/contextual information of a content to be shared, location of the UE 101, a target recipient group, any security keys, and the like before the content item is broadcast. In one embodiment, the AS module 111 may re-determine the sharing rules based on one or more changes/updates to the user profile of a sharing device, geo-location change, change in time, and the like. For example, the service 108 may initiate a request for generation or acquisition of a token in response to user request to associate/connect with another user of the social networking service 108. Under this scenario, an acknowledgement rule may apply for indicating user acceptance of said token as a means of triggering its transmission.

It is noted that the awareness services module 111 may operate in connection with the token sharing manager 103 for supporting the above described token sharing exchange. For example, the token sharing manager 103 may initiate execution of the awareness services module upon determining the UE 101 accesses a service 108 (e.g., social networking service) via the communication network 109. As such, the awareness services module 111 may be implemented as an application programming interface, widget or other executable component for use with the token sharing manager 103. Still further, the token sharing platform 105 may be adapted to operate in connection with the awareness services module 111 for enabling the exchange of tokens common to different user equipment 101 of the ad hoc mesh network 115.

FIG. 1B is a diagram of components of a token sharing platform, according to one embodiment. It is contemplated that the functions of these components may be combined in one or more components or performed by other components of equivalent functionality. In this embodiment, the token sharing platform 103 includes an authentication module 131, a token retrieval module 133, a token linking module 135, a user interface module 137 and a communication module 139. The token sharing platform 105 may also access a database 117 for maintaining profile data regarding respective users of UE 101 that exchange tokens based on a common affiliation.

In one embodiment, the authentication module 131 authenticates users and user devices 101a-101n for interaction with the token sharing platform 105. By way of example, the authentication module 131 receives a request to subscribe to the platform 105 or alternatively, performs the authentication based on a login procedure with a service 108 of the user. This may include, for example, a social networking service. It is noted that the authentication may include a first time subscription procedure for establishing one or more profile settings. As such, subsequent access is carried out by the module 131 by validating a login name, user identification value, device identifier or the like. It is noted that the authentication procedure may also be performed through automated association of the profile data 117 with an IP address, a carrier detection signal of a user device, mobile directory number (MDN), subscriber identity module (SIM) (e.g., of a SIM card), radio frequency identifier (RFID) tag or other identifier.

In one embodiment, the token retrieval module 113 and token linking module 135 interact the UE 101 to enable the retrieval and subsequent storing of a token at a corresponding UE of users in common. By way of example, the token retrieval module 133 initiates activation of the camera 113 of the UE 101 in response to a determination that a user at a first UE 101 has identified an association with another user, i.e., befriending another user via a social networking service. Under this scenario, the token retrieval module 133 may initiate a command for prompting the associated users to “take a friendship photo.” The command may be rendered to a user interface of the UE 101 by way of a user interface module 137. The module 133 may then detect acceptance of the captured photo as provided as input to the UE 101 by the user.

In one embodiment, the token linking module 135 links the token, once accepted, to the respective users of UE to which the token is to be shared. By way of example, the token linking module determines a location, identifier, or other information for indicating which users, UE 101 or the like are to receive the token. Under this scenario, in the case of a photo being captured at a first UE 101 in response to a befriending event between social network participants, the token linking module 135 identifies pertinent associative information for the participants. The module 135 then stores this information to the profile of the user of the first UE 101, thus maintaining data for indicating the association between the first UE 101 and the second UE 101.

In one embodiment, the token linking module 135 operates in connection with the communication module 137 to facilitate transmission of the token (upon capture) between respective UE 101. The transmission occurs based on the information acquired by the token linking module 135 regarding the users and/or UE associated with the captured token. Under this scenario, when a token (e.g., photo) is accepted by a first UE 101, the photo is automatically saved and set as the avatar image for the second user. Hence, the image is automatically transferred to a second UE corresponding to the second user, stored and set as the photo to correspond to the user of the first UE. This process is performed seamlessly such that the photo is integrated at the second UE without any intervention by the second user.

Still further, in certain embodiments, the token linking module 135 may enable the processing of the token as a shortcut for facilitating a linking between users and/or UE 101 in common. For example, the token linking module 135 token may enable the token (as captured or retrieved) to be added/embedded to the user interface of the UE as a ‘shortcut.’ The user interface may correspond to that of the social networking service, a desktop of the UE, or the like, wherein the shortcut facilitates user access to the associated record, social networking service, or any other associated communications ‘channel’ that connects the users. It is noted, therefore, that the token may serve as a link or compliment to existing contact information of the users in common.

It is noted that the above described transference approaches may also be carried out by the communication module 137 in conjunction with the awareness services module 111. As such, the communication module 137 may invoke execution of the awareness services module 111 for performing sharing of tokens via an ad hoc network 115. Still further, as an alternative to physical transference of the token to UE 101, the transfer procedure may include an uploading of the token to the service 108 in connection with a profile 117 of the second user. For example, the token as captured via a first UE may be uploaded and/or linked to the profile of the other user featured in the photo—i.e., presented as an avatar at the other user's device, contact manager, service, etc. In this way, the token may be retrieved automatically and rendered to a contact list, contact card or profile view (associated with the user of the first UE) when the user of the other UE accesses the social network 108.

Still further, the common token may be transmitted via the communication module 137 to all involved users by way of an email, short message service (SMS), virtual card, or the like depending on the target UE that is to receive the token. Per this approach, the token can be stored or set as an avatar with respect to the sending user. Hence, the token sharing platform 105 may further enable automated generation of said messages for conveying the token, thus requiring no selection and/or sending of said message by the user of the UE 101 that generated and/or acquired the token.

In one embodiment the user interface module 139 enables presentment of a graphical user interface for presenting the token or the instructions for establishing the token. By way of example, the user interface module 215 generates the interface in response to application programming interfaces (APIs) or other function calls corresponding to the social networking service 108 or applications of UEs 101; thus enabling the display of graphics primitives. Of note, the user interface module 215 may operate in connection with the token linking module 135.

In one embodiment, a communication module 139 enables formation of a session over a network 109 between the token sharing platform 105 and the token sharing manager 103. By way of example, the communication module 139 executes various protocols and data sharing techniques for enabling collaborative execution between a subscriber's UE 101 (e.g., mobile devices, laptops, smartphones, tablet computers, desktop computers) and the platform 103 over the network 109. It is noted that the communication module 139 is also configured to support a browser session—i.e., the retrieval of content as referenced by a resource identifier during a specific period of time or usage of the browser. The browser session may support execution of the token sharing manager 103 as well as online access to services 108 and other functions.

It is noted that the above described approaches enables users of UE 101 to readily create a shared token that is representative of their relationship, i.e., a pose of the user's in the same picture; that is automatically shared with all of the users involved. As such, this token may then be subsequently utilized at respective UE of said involved users, thus facilitating/representing the special bond between them. By utilizing the token (e.g., as the avatar image) to associate with the users in common, the image is shown again to the users every time they access the contact card, view social updates (e.g., chat messages, posts, event notices), or receive a call/create a call to that person. In addition, the token may serve as a shortcut/link to contact information of the users in common. It is contemplated, in certain embodiments that the token may also be a document, file, or other object, such that this object is rendered to respective users accordingly. For example, a document representing an agreement, poem, affirmation or the like relating to the users may be presented in association with a contact card for the respective users.

The above presented modules and components of the token sharing platform 105 can be implemented in hardware, firmware, software, or a combination thereof. For example, although the token sharing platform 105 is depicted as a separate entity or as a hosted solution in FIG. 1, it is contemplated it may be implemented for direct operation by respective UEs 101. As such, the token sharing platform 105 may generate direct signal inputs by way of the operating system of the UE 101 for interacting with (or as) the token sharing manager 103. Alternatively, some of the executions of the above described components may be performed at the UE 101 while others are performed offline or remotely per a client server interaction model between the UE 101 and the platform 105.

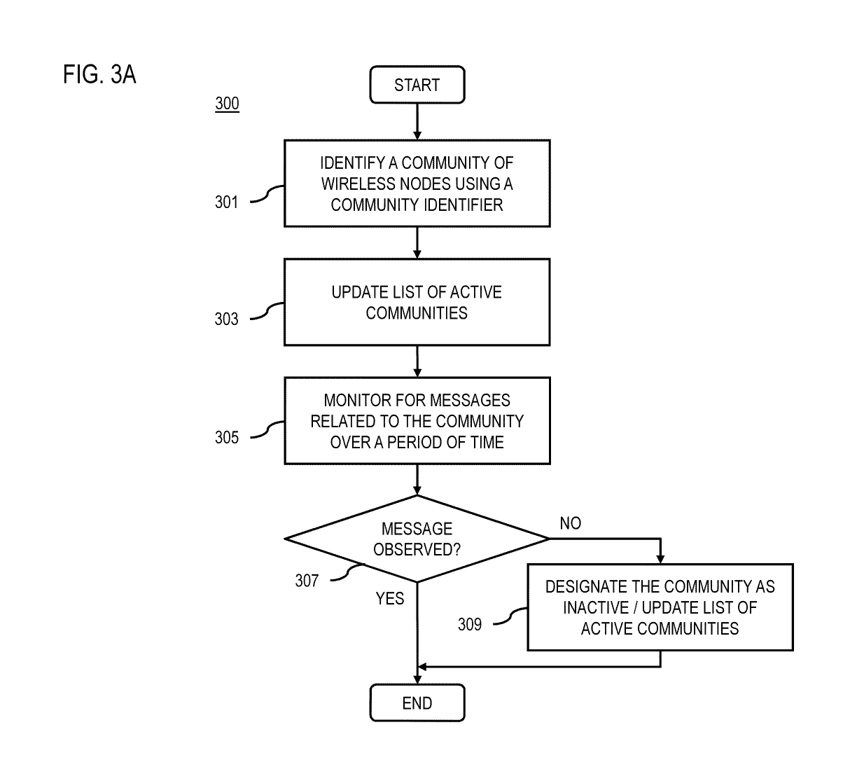

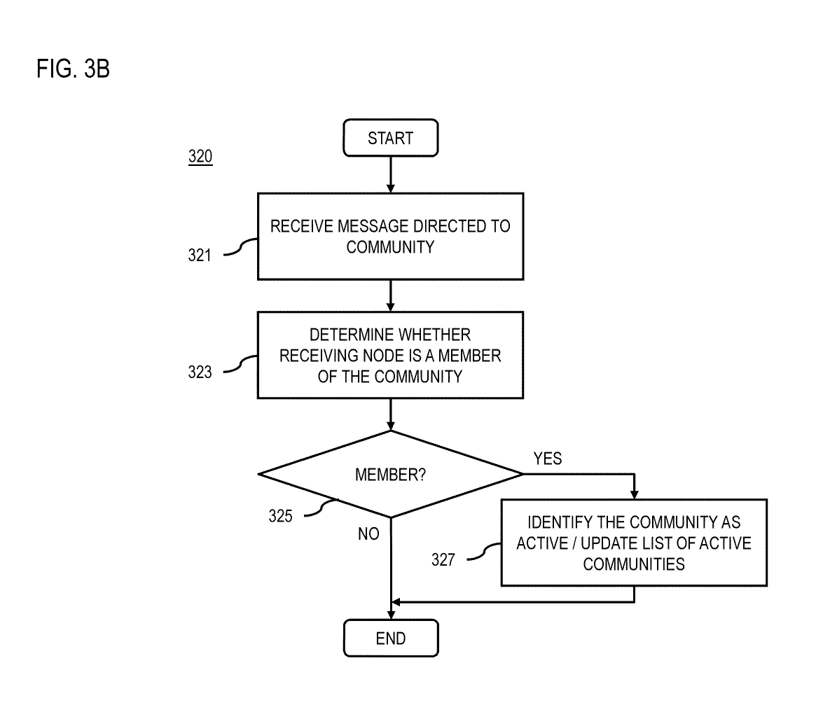

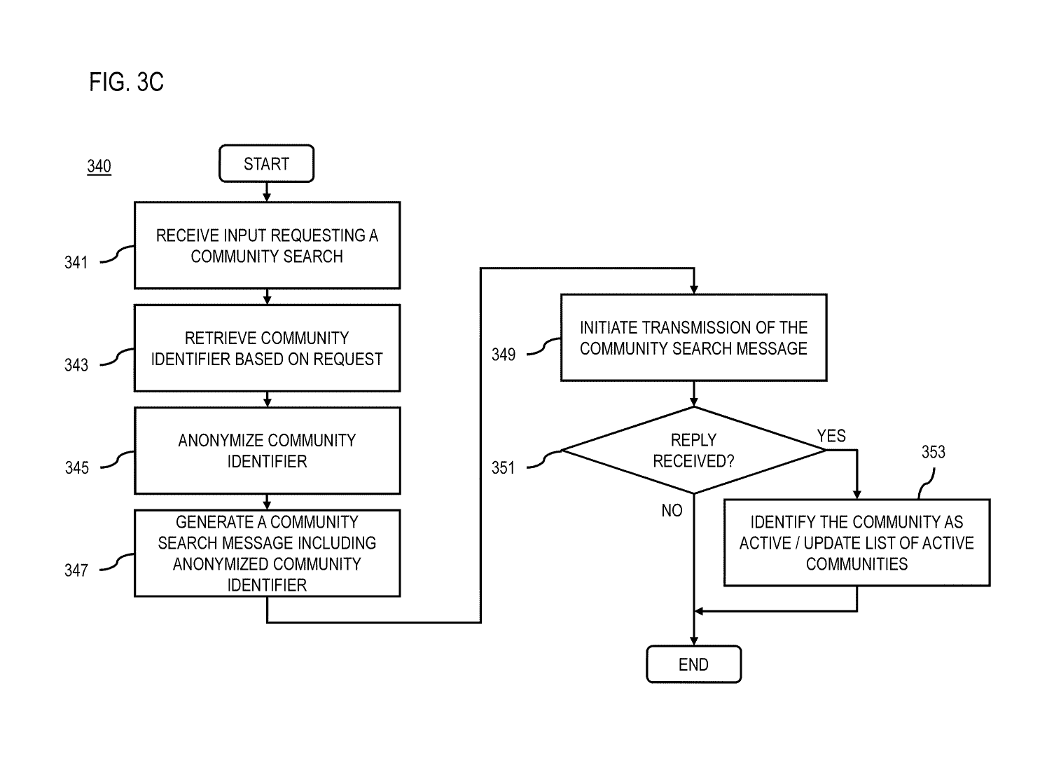

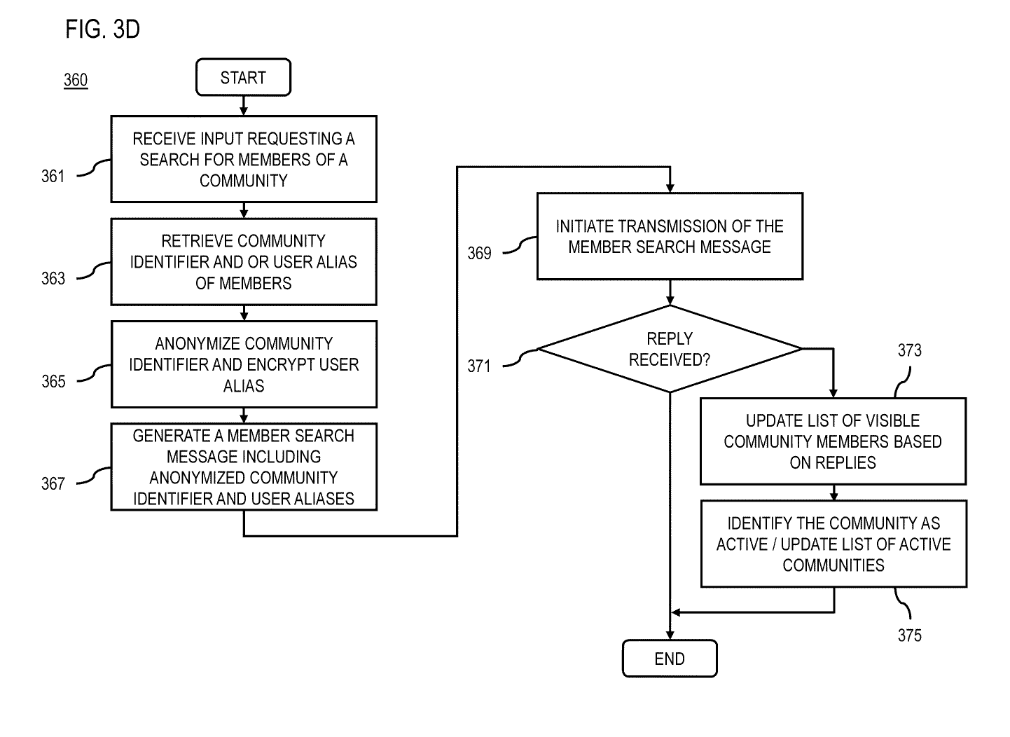

The foregoing paragraphs describing FIGS. 2A-5B present an exemplary communication scheme for enabling the sharing of tokens among wireless nodes (e.g., UE 101a-101n) per the token sharing platform 105. This includes, for example, the transfer of tokens via an ad hoc networking scheme as executed at least in part via an awareness services module 111. While an ad hoc networking implementation is presented in FIGS. 2A-2G and then subsequently in FIGS. 3A and 3B, 4 and 5A and 5B, it is noted that these implementations are for illustration purposes only. Hence, the above described token exchange approaches may be carried out according to any known communication scheme.

FIG. 2A is a diagram of the components of a wireless node including an awareness services module, according to an embodiment. FIG. 2A is described with respect to FIGS. 2B-2E which are diagrams of the components of the awareness services module 111, according to various embodiments. As shown in FIG. 2A, a wireless node 101 (e.g., a UE 101) may include one or more components for sharing awareness information within the ad hoc network 115. In addition, the awareness services module 111 facilitates the transfer of tokens generated. It is contemplated that the functions of these components may be combined in one or more components or performed by other components of equivalent functionality. In one embodiment, the wireless node 101 includes an application 201 that uses awareness information to provide various services and functions including social networking, location-based services, presence information, context determination, advertising functions, etc. The application 201—i.e., the token sharing manager 103—may interact with the AS module 111 to obtain or share awareness information.

By way of example, the AS module 111 includes three layers: a cognition layer 203, a community layer 205, and a network layer 207. The cognition layer 203 is the highest control layer for sharing awareness information. As shown in FIG. 2B, the cognition layer 203 includes a control logic 221 and item storage 223. The control logic 221, for instance, provides the logic for creating, publishing, querying, and receiving awareness information over the ad hoc network 115. The control logic 221 can store the information that it either creates or receives in the item storage 223. It is contemplated that the item storage 223 may be of sufficient size to store all or a portion of the information that flows through the wireless node 101 over a configurable period of time (e.g., days, months, or years).

In various embodiments, the control logic 221 enables querying and dissemination of awareness information by initiating the broadcasting of the query or information to neighboring UEs 101 within the ad hoc network 115. For example, upon receiving a query, the UEs 101 in the local neighborhood that have the queried information reply to the querying node automatically. In various embodiments, the reply information is also automatically stored in the item storage 223 of each wireless node 101 through which the propagating reply passes. Moreover, the reply to a query may result in return of a pointer to specific content relevant to the query rather than the content itself under certain circumstances (e.g., when the specific content is large in size). It is contemplated that the reply may contain direct content if the content is relatively small (e.g., a few tens of bytes of information). By using a pointer, the system 100 minimizes the data traffic that flows through the ad hoc network 115. The user may then access the content via the pointer (e.g., a universal resource locator (URL) address, IP address) via a more appropriate communication protocol (e.g., IP) and/or means of communication (e.g. infrastructure networks). The receipt of the pointer (e.g., IP address) may automatically trigger the transfer of the content using, for instance, the communication protocol associated with the pointer. In the case of broadcasting or publishing information, any wireless node 101 through which the published information propagates may store the information in item storage 223 of the wireless node 101.

In various embodiments, awareness information can also be published directly by broadcasting an awareness message. Such a push mode for the dissemination of awareness information can be used to support some applications (e.g. advertising or group chatting) over the ad hoc network 115.

It is recognized that privacy and anonymity may be of concern to users of the system 100. Accordingly, the control logic 221 provides mechanisms for ensuring privacy and anonymity. For example, the control logic 221 can prevent the transmission of intimate information when the number of neighboring wireless nodes is small to prevent the possibility of inferring identity. As used herein, the term “intimate information” refers to information directly related to the user, e.g., the user's habits, tastes, or preferences (musical preferences, favorite restaurants, etc.).

The control logic 221 may also periodically broadcast decoy queries and replies to make tracking an individual wireless node 101 more difficult. Since an outside observer does not know the authentication key associated with a community, the observer cannot distinguish a valid message from a fictitious one. Accordingly, by observing decoy messages, the observer is likely to detect presence of a private community when there is not one. Additionally, the control logic 221 enables to user to define filters for incoming information (e.g., filter advertisements) and how these filters would work (e.g., ignore the information completely, relay the information but do not store, etc.). It is also contemplated that the user can direct the control logic 221 to control the user's visibility on the ad hoc network 115 (e.g., no visibility, visible only to a certain community or other user) to maintain privacy. As another mechanism for protecting privacy, the control logic 221 can interact with the community layer 205 to anonymize a specific message and corresponding identifiers as described below with respect to the community layer 205.

Because one of the goals of the system 100 is to provide a mechanism for anonymous spreading of awareness information, it is recognized that undesired or unsolicited messages (e.g., spam messages) may become a problem. To address this problem, the control logic 221 may obtain, for instance, information from the lower system layers of the AS module 111 about the traffic load and current average power consumption. If the traffic load is medium or high (meaning that also power consumption related to system 100 is medium or high) restrictions may be set for the frequency at which broadcasting messages are sent by the control logic 221. It is also contemplated, that the neighboring peer nodes 101 can be configured to not forward any broadcasting messages originating from a node 101 neglecting such message restrictions.

The cognition layer 203, together with the community layer 205, provide an application programming interface (API) 225 to enable an application 201 to access the functions of the control logic 221 and the item storage 223. In various embodiments, the API 225 enables application developers to have uniform and easy access to functions related to sharing awareness information over the ad hoc network 115. It is contemplated that the API 225 is extensible to accommodate any application designed to access or use awareness information. The applications in the various nodes 101 do not have to be the same or mutually compatible. It is sufficient that the applications use the API correctly to be able to publish and search awareness information in the surrounding nodes 101.

The cognition layer 203 also has connectivity to the community layer 205. The community layer 205 controls the formation and cataloging of communities of UEs 101 within the ad hoc network 115. By way of example, a user may create any number of communities for sharing awareness information. It is contemplated that a community may be either a peer community (e.g., any wireless node 101 may join), a personal community (e.g., a wireless node 101 may join only if invited), or the open local community that consists of all nodes in the local neighborhood. In various embodiments, the messages that traverse between the UEs 101 within the ad hoc network 115 belong to one of these three community types. Communities can either be private (messages are encrypted) or public (no encryption used). In various embodiments, membership and status in a community affect how the wireless node 101 shares awareness information (see the discussion with respect to FIG. 2G for additional details of community membership).

Furthermore, a community may be created for any purpose or duration (e.g., a permanent work community, a permanent community of friends, and a temporary community of concert goers lasting only the duration of the concert). As shown in FIG. 2C, the community layer 205 includes a community control module 241, a community directory 243, and an encryption/decryption module 245. The community control module 241 provides the logic for creating, joining, managing (e.g., updating membership, configuring settings and preferences, setting privacy policies), and deleting communities. The module 241 also provides part of the API 225.

In various embodiments, the community control module 241 assigns a unique community identification number (CID) to each community for use within the ad hoc network 115. The control module 241 can also generate authentication keys K associated with the CID to, for instance, authenticate users who wish to join the community or authenticate messages directed to the community. For example, a wireless node 101 may invite another wireless node 101 to join a community by transferring the CID and authentication keys associated with the community to the other wireless node 101. It is contemplated that the transfer of the CID and corresponding authentication key may occur using short range radio or using another secure mechanism (e.g., short message service (SMS) or electronic mail). It is noted that both peer and personal communities use a CID and corresponding K, whereas the open local community either can use a predetermined value for CID (e.g., zero) or does not use the CID at all.

To ensure privacy (as discussed above), the community control module 241 interacts an encryption/decryption module 245 to anonymize the CID when including the CID in messages over the ad hoc network 115. For example, a wireless node 101 may direct a query to a specific community using an anonymized CID (e.g., a pseudonym) associated with the community in lieu of the actual CID. In various embodiments, multiple anonymized CIDs may be used to represent a single community. In this way, it is more difficult to identify queries corresponding to a particular community by monitoring traffic within the ad hoc network 115. From the perspective of an outside observer, the anonymized CIDs look random. In addition, the encryption/decryption module 245 may encrypt or decrypt message data using, for instance, a temporary key that is periodically derived from the authentication key K associated with the CID. These measures hinder the discovery of the CID by outsiders that do not have the authentication key. By way of example, the community layer 205 inserts a special header into the messages that it receives from the cognition layer 203. The special header, for instance, contains a list of anonymized community identifiers corresponding to the communities to which the message is relevant.

FIG. 2D is a state diagram of the effect of community membership and status on sharing awareness information, according to an exemplary embodiment. As shown in FIG. 2D, a wireless node 101 may be in either one or two states (e.g., a not-joined state 251 and a joined state 253) with respect to membership in a community within the ad hoc network 115. The application 201 of wireless node 101 issues, for instance, a command 255 to either join or leave a community to transition between the not-joined state 251 and the joined state 253. When the wireless node 101 is in the not-joined state 251 with respect to a community, the wireless node 101 has no information (e.g., CID and associated authentication keys K) about the community and cannot access messages directed to the community. When the wireless node 101 is in the joined state 253, the community layer 205 receives the CID and possibly one or more authentication keys associated with the community. In one embodiment, authentication keys are provided when membership in the community is by invitation or otherwise restricted (e.g., when the community is a personal community or a private community). Accordingly, the community layer 205 will be able to encrypt outgoing community specific messages and to decrypt incoming community specific messages.

When the wireless node 101 is in the joined state 253, the wireless node 101 may also be in either an inactive state 257 or an active state 259. To transition between the inactive state 257 and the active state 259, the application 201 may issue a command 261 to either activate or deactivate the joined state 253 via the application programming interface 225. When the wireless node 101 is in the inactive state 257, the community layer 205 abandons the message even though it is a member of the community. In certain embodiments, the wireless node 101 may also be invisible to other members of the community while in the inactive state 257. For example, the wireless node 101 may enter the inactive state 257 when it temporarily does not want to receive or share information with the community. When the wireless node 101 is in the active state 259, the community layer 205 encrypts and decrypts community messages as usual for private communities, and enables all outgoing and incoming community specific messages for public communities (e.g., communities with no restrictions on membership).

Within the active state 259, the wireless node 101 may also be in either an invisible state 263 or a visible state 265. To transition between the invisible state 263 and the visible state 265, the application 201 issues a command 267 to set either the visible or invisible state. When in the invisible state 263, the community-specific identity (e.g., a user alias) associated with the wireless node 101 cannot be queried by other members of the community. For example, in the invisible state 263, the community layer 205 continues to receive and send community messages without its identity known to other community members. When in the visible state 265, the identity of the wireless node 101 can be queried by other members of the community.

In various embodiments, the community directory 243 of the community layer 205 maintains, for instance, information on the communities that the user has joined. Such information contains, at least, the community identification (CID). Additionally, it may contain public and/or private authentication keys (K) of the joined communities and a list of anonymized community identifiers for each community. The community control module 241 may periodically recalculate the list of anonymized CIDs. By way of example, the community layer 205 inserts a header into the message it receives from the cognition layer 203. The header contains, for instance, a list of anonymized community identifiers identifying the communities to which the message is relevant.

It is contemplated that a special personal community can be reserved for tracking new bonds or relationships created between users. Consider, for example, that user A meets user B for the first time and wants to create a radio bond between the mobile devices corresponding to each user. In one embodiment, user A can initiate the creation of this bond with user B by transferring to user B (e.g., by using a secure transfer mechanism) the CID and the public K of user A's personal “new bonds” community. Similarly, user B may give user A similar credentials corresponding to user B's “new bonds” community. Once the credentials are exchanged and the bond has been created, user A may find user B over the ad hoc network 115 by searching for members of user A's “new bonds” community. In other words, with a simple search of a single community, user A can search for all the people in user A's local neighborhood with whom user A has created a bond. This requires that a high number of community CIDs and Ks can be stored in the community directory 243. Also, an effective lookup of the community directory must be provided. There are many existing and good solutions for such efficient lookup.

As the user creates new bonds, the number community CIDs and Ks stored in the user's community directory 243 can grow quite large. Accordingly, to enable effective search of a large number of communities, the community layer 205 may generate a special community search message to initiate the search. For example, the special community search message contains, at least in part, a list of anonymized community identifiers corresponding to the communities to be searched. To protect the privacy, the community layer 205 can generate a new set of anonymized community identifiers for each community search message. If the community layer 205 finds a match to any of the anonymized community identifiers in any of the neighboring nodes 101 that receives the search message, the community layer 205 generates a reply message that may contain the alias of the user in that community or other community specific information. The reply message may be encrypted with the encryption key of the community.

As shown in FIG. 2C, the community layer 205 has connectivity to the cognition layer 203 above and the network layer 207 below. The network layer 207 manages the rebroadcasting of received broadcasting messages and the routing of the unicast (typically reply) messages received by the wireless node 101. FIG. 2E depicts a diagram of the components of the network layer 207, according to an exemplary embodiment. The network layer 207 includes a network control module 271, routing table 273, neighbor table 275, message identification (MID) table 277, and message table 279. The network control module 271 directs the broadcasts of messages and information by managing and updating the routing table 273, neighbor table 275, MID table 277, and message table 279. In certain embodiments, the network control module 271 may also assist in protecting the privacy and anonymity of users by periodically changing the network layer identification associated with the wireless node 101. It is noted that making such a change in the network layer identification between queries does not cause routing problems for replies because the routing information is recreated by each query in the ad hoc network 115.

In various embodiments, the network layer 207 may insert a header into messages it receives from the community layer 205 to, for instance, direct broadcasting and routing of the received messages. The structure of this network layer message header 281 is discussed with respect to FIG. 2F. FIG. 2F is a diagram of the data structure of a network layer message header, according to an exemplary embodiment. As shown, the message header 281 contains the following fields: (1) a TX field 282 to identify the transmitter node ID (NID) of the last transmitting node 101; (2) a SRC field 283 to identify the source node ID of the node 101 that originated the message; (3) a DST field 284 to identify the destination source ID of the intended recipient of a unicast (reply) message (e.g., this field is give a value of zero when the message is a broadcasting messages); (4) a MSN field 285 to identify the message sequence number assigned by the source node; and (5) a hop count field 286 that is incremented by one by each node 101 that transmits the message. In certain embodiments, the message header 281 may also contain the following optional fields: (6) a geographical limit field 287 to designate the extent of the physical over which the message is intended to propagate (e.g., the geographical limit field 287 may contain a geographical position of the source node and a maximum broadcasting radius from that position); (7) a temporal limit field 288 (e.g., the temporal limit field 288 may contain the time when the message becomes obsolete and should be dropped); and (8) a context limit field 289 that defines the context beyond which the message is not intended to propagate (e.g. a message related to a particular concert is not intended to extend beyond the concert venue).

Returning to FIG. 2E, the network layer 207 also contains a routing table 273. In various embodiments, the routing table 273 contains a listing of the node identification number (NID) of the originating wireless node 101 (e.g., source NID) and the NIDs of the last known transmitters of the message. The purpose of the routing table is to enable the routing of the reply messages (e.g., unicast messages) back to the querying node that originated the query through a broadcasting message. As the message propagates through the ad hoc network 115, each subsequent wireless node 101 that receives the message adds the NID of the last transmitter to the routing table to record the next hop neighbor towards the source node. The source node is marked as the destination node (DST) in the routing table. Also the message sequence number of the message is recorded. The update of the routing table 273 is coordinated by the network control module 271. As shown in Table 1, the routing table 273 lists the destination NID, the transmitter NIDs associated with UEs 101 that have rebroadcasted a message and the MSN of the message.

TABLE 1

| Destination NID | Transmitter NIDs | Message Sequence Number |
|---|---|---|
| DST₁ | TX₁₁, TX₁₂, . . . , TX_{1M} | MSN₁ |
| DST₂ | TX₂₁, TX₂₂, . . . , TX_{2N} | MSN₂ |
| . . . | . . . | |
| DST_{S} | TX_{S1}, TX_{S}, . . . , TX_{ST} | MSN_{S} |

The neighbor table 275 contains a list of the neighboring UEs 101 and an estimate of their relative radio distance (see Table 3). It is contemplated that the observed signal strength together with the known transmitting power of a neighboring wireless node 101 is an indicator of the proximity of the wireless node 101 and can be used to calculate the relative radio distance. The relative radio distance of the node from which the message was last received is then used as a criterion for whether or not the wireless node 101 retransmits a received message. For instance, a higher signal strength indicates closer proximity to the wireless node 101. The network control module 271 monitors the signal strengths of neighboring nodes 101 as the module 271 receives messages from nearby devices and uses it to estimate the relative radio distance (e.g., proximity of the transmitting node 101). It is also contemplated that the network control module 271 may use any other mechanism for estimating the relative radio distance of neighboring nodes (e.g., estimating location using global positioning satellite receivers or other positioning techniques).

In certain embodiments, the network control module 271 uses the proximity information to direct the routing and transmission of messages over the ad hoc network 115. For example, the system 101 can reduce the potential for overloading the ad hoc network 115 by implementing a smart broadcasting scheme whereby only a few nodes 101 retransmit a broadcasting message. Whether a node 101 retransmits a broadcasting message can be dependent on the relative distance group (e.g., “very near”, “near”, or “far”) to which the node 101 that is the transmitter of the message belongs. More specifically, if the transmitting node 101 is in the “far” or “near” group, the receiving node 101 can retransmit the broadcasting message. If the transmitting node 101 is in the “very near” group, the receiving node 101 does not retransmit the broadcasting message. For each broadcast message received from a node in either the “far” or “near” group, the network control module 271 assigns a random delay time for relaying or rebroadcasting. The delay period, for instance, exhibits a distribution function based on the estimated relative radio distance as a way to randomize the delay period before transmission. The distribution should be chosen in such a way that the random delay is larger for those nodes that are “near” than for those that are “far.” This favors, for instance, nodes 101 that are further away to relay the broadcasting message forward, which results in better broadcasting efficiency (smaller total number of transmissions). The use of a random delay time also prevents the unintended synchronization of message broadcasts as the message propagates over the ad hoc network 115. For example, unintended synchronization of the message broadcasts may result in too many nodes 101 sending broadcasting (i.e., flooding) messages over the ad hoc network 115 at exactly the same time. Additionally, the delay time provides an opportunity for the network control module 271 to monitor and count rebroadcasts of the message by other neighboring UEs 101.

TABLE 2

| Transmitter NID | Relative Radio Distance |
|---|---|
| TX₁ | D₁ |
| TX₂ | D₂ |
| . . . | . . . |
| TX_{T} | D_{T} |

The MID table 277 contains a list of received messages. As the wireless node 101 receives messages from neighboring nodes over the ad hoc network 115, the network control module 271 uses the MID table to check whether the message has been received previously by, for example, comparing the MIDs in the MID table 277 to that of the received message. The MID table 277 also contains a flag indicating whether a message has been transmitted by the node 101 and the time when the entry was last updated. In various embodiments, the MID is the tuple (SRC, MSN), where SRC is the NID of the source node and MSN is a message sequence number assigned by the source node. In this way, the MID is a unique identifier of each message that propagates in the network 115. The network control module 271 makes an entry in the MID table 277 for all new messages that it receives. If the message has been scheduled for transmission, the module 271 increments the message counter in the message table (see Table 4).

TABLE 3

| MID | Sent flag | Time of reception |
|---|---|---|
| (SRC₁, MSN₁₁) | “SENT” | t₁₁ |
| (SRC₁, MSN₁₂) | “NOT SENT” | t₁₂ |
| . . . | . . . | . . . |
| (SRC₂, MSN₂₁) | “NOT SENT” | t₂₁ |

The message table 279 contains messages that the network control module 271 has scheduled to transmit. For example, as the node 101 receives a broadcasting message that the network control module 271 schedules for transmission, the module 271 updates the message table to include the message in the message table 279. Each entry in the message table 279 contains the message itself, the time when the message is scheduled to be sent, and the number of receptions of the same message by the node 101 (see Table 4). In various embodiments, a message is not relayed over the ad hoc network 115 if the number of times the message has been received exceeds a predefined limit. For example, a message has the initial count of 0. In this example, as a wireless node 101 in the neighborhood is observed to transmit the message, the message count associated with the message is increased. When the maximum message count is reached, the network control module 271 removes the message from the message table 279. The transmitter of each message is also associated with an estimated relative radio distance (D) indicating whether the transmitting node is within close proximity of the wireless node 101 (e.g., transmitting node 101 is in the “very near” relative radio distance group) or far from the wireless node 101 (e.g., transmitting node 101 is in the “far” relative radio distance group). If the relative radio distance associated with the transmitting node indicates that the transmission of the message occurred “very near,” the wireless node 101 would not have to relay the message because it is assumed, for instance, that most of the other neighboring UEs 101 have already received the same message. By taking into account the relative radio distances of neighboring nodes, the described smart broadcasting functionality leads to, on average, each broadcasting message being received for a few times by each node 101 independent of the node density. The number of times a message is received by any one node 101 affects the scalability of the network 115.

If the received message, however, is a unicast reply message that was addressed to the receiving node 101, the network control module 271 checks whether the destination node 101 can be found in the routing table 273 (e.g., can be found from the destination field in the reply message, or obtained from the source field of the query by the replying node). If found, the routing table entry will give the NID of the neighboring node to which the reply message will be sent in the next opportunity. If the unicast transmission is not successful, the next entry for the same DST will be used as the next try. If the received message is a unicast reply message that was not addressed to the receiving node, and no acknowledgment from the intended receiver node was heard, the node will store the message in the message table 279 for scheduled retransmission. It is noted that unicast messages or acknowledgement messages that are not addressed to the node 101 are normally received D2D radio layer 209 (see discussion of the D2D radio layer 209 below) but not by the AS module 111. However, under certain circumstances, the D2D radio layer 209 can provide such messages to the AS module 111 to schedule for retransmission. For example, if no successful unicast of the same message is observed by the time when the message is scheduled to be transmitted, the node 101 will transmit the unicast or acknowledgement message to the intended recipient found from the routing table 273 associated with the message. In this way, the nodes 101 that are not the intended recipients of the reply messages can assist in routing the message forward towards the correct destination.

TABLE 4

| Message | Time to send | Received msg count |
|---|---|---|
| MSG₁ | t₁ | C₁ |
| MSG₂ | t₂ | C₂ |
| . . . | . . . | . . . |
| MSG_{M} | t_{M} | C_{M} |

As shown in FIG. 2A, the AS module 111 has connectivity to a device-to-device (D2D) radio layer 209. The D2D radio layer 209 enables the formation of the ad hoc network 115 and sharing of awareness information using, for instance, short range radio technologies such WLAN and Bluetooth®. It is contemplated that the D2D radio layer 209 may use any wireless technology for communication between devices over short ranges. The radio technology, for instance, enables each wireless node 101 within the ad hoc network 115 to broadcast messages in a connectionless way to the neighboring nodes 101 that are within radio range. As used herein, the term “connectionless” means the UEs 101 need not use two-way signaling to establish a communication channel before broadcasting a message. In various embodiments, the D2D radio layer 209 may include multiple radios using one or more different technologies or protocols (e.g., WLAN and Bluetooth® simultaneously). A wireless node 101 configured with multiple radios may act as a gateway node to span two or more sub-networks serviced by the different wireless technologies. In this way, messages broadcast on one sub-network may be propagated to another sub-network.

FIG. 2G is a diagram depicting a power saving scheme of a device-to-device radio layer, according to an exemplary embodiment. The small amount of awareness data as well as the low latency requirements of the system 100 enables the operation of the D2D radio layer 209 in a way that leads to low power consumption. As shown in FIG. 2G, the D2D radio layer 209 may have beaconing periods 291a-291c delineated by target beacon transmission times (TBTTs) 293a-293c. In various embodiments, the D2D radio layer 209 may operate in a time-synchronized manner and utilize only a fraction of the time for active communication (e.g., during awake periods 295a-295c). During the rest of each beaconing period 291, the D2D radio layer 209 is in, for instance, a power-saving or dozing mode (e.g., during doze periods 297a-297c). For example, each beaconing period 291 can be on the order of hundreds of milliseconds and each awake period 293 only a few milliseconds, leading to effective radio utilization of approximately one percent. It is contemplated that for situations, where the number of nodes 101 is very large (such as during mass events), time-wise radio utilization can increase up to 100 percent momentarily (e.g., awake period 293 equals active transmission period 291). At times of low traffic (for example at night), the radio utilization can be decreased to, for instance, 0.1 percent, by utilizing every tenth awake period 293 while still maintaining synchronization.

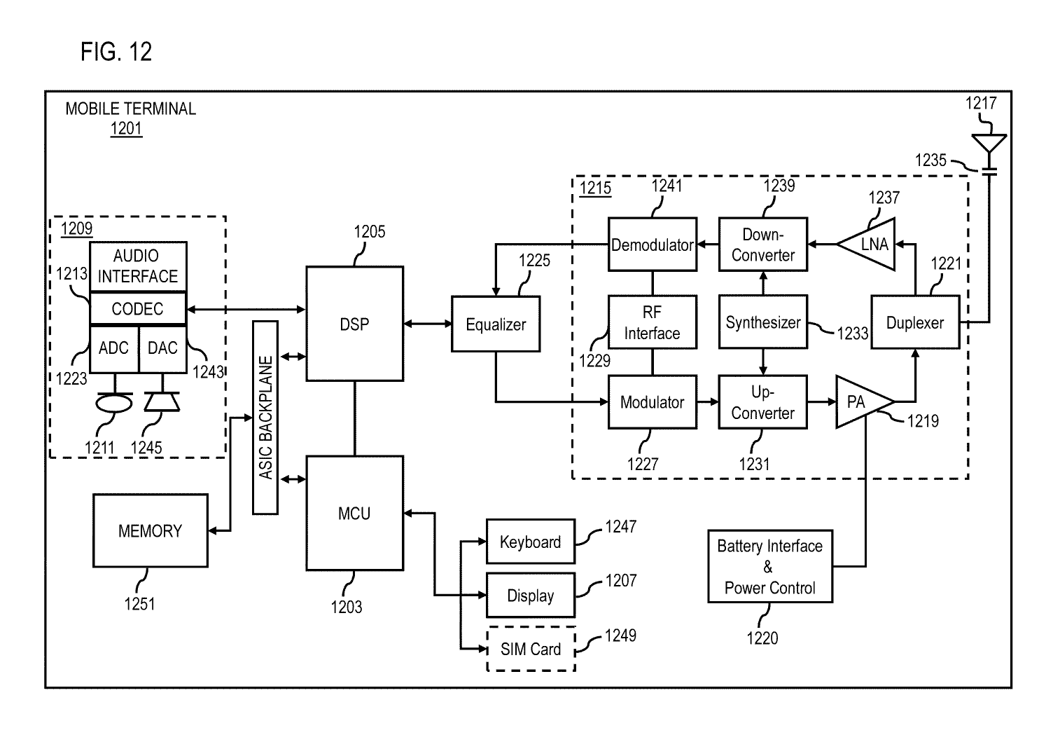

In various embodiments, the low latency requirements also enable saving power in the host processor (e.g., as depicted in FIG. 12). For illustration, the following description refers to the components of exemplary chip set of FIG. 12. The D2D radio layer 209 is typically implemented in the ASIC module 1209, whereas the functionalities of the AS module 111 can be implemented either in the ASIC 1209 or the processor 1203. If the functionalities of the AS module 111 are implemented in the processor 1203, power consumption is reduced by, for instance, having ASIC 1203 wake up the processor 903 as infrequently as possible. By way of example, the periodic operation of the D2D radio layer 209 explained above enables the ASIC 1203 to collect all messages and send them to the processor 1203 at a frequency of once per active transmission period 291. The processor 903 then processes all received messages and calculates new messages to be sent for the next active transmission period 291. The processor 1203 then sends the messages to the ASIC 1203 for transmission. Using this process, a broadcasting message can make one hop (e.g., travel from one node 101 to another node 101) per period 291, which is fully acceptable for awareness information. In contrast, potential delays of hundreds of milliseconds are not possible, for example, for voice traffic, and these kinds of power savings cannot therefore be achieved in other communication systems transporting delay-sensitive traffic.

FIGS. 3A-3D are flowcharts of processes for locating communities and community members in the local neighborhood over an ad hoc network, according to various embodiments. FIG. 3A is a flowchart for locating active communities over the ad hoc network 115 and updating a list of the active communities that are visible to a wireless node 101. In one embodiment, the AS module 111 performs the process 300 of FIG. 3A and is implemented in, for instance, a chip set including a processor and a memory as shown in FIG. 12. In step 301, the AS module 111 identifies one or more communities of UEs 101 by using, for instance, community identifiers (CIDs) corresponding to the one or more communities. In various embodiments, each CID is associated with one or more authentication keys for authenticating members and messages transmitted within the corresponding community. The CIDs and associated keys are stored by the AS module 111 in, for instance, the community directory 243 and may be provided to UEs 101 that are members of the community in advance using a secure communication channel over the ad hoc network 115 or the communication network 109. CIDs and keys that are created subsequently may also be provided using a secure communication channel over either the ad hoc network 115 or the communication network 109.

By way of example, the AS module 111 can use the CIDs to locate and identify communities that are active (e.g., transmitting or receiving community messages) among one or more neighboring UEs 101 by (1) passively monitoring messages directed towards one or more communities over the ad hoc network 115 using the process described with respect to FIG. 3B below, (2) actively searching for one or more communities using a community search message as described with respect to FIG. 3C below, and/or (3) actively searching for one or more members of the communities using a member search message as described with respect to FIG. 3D. The AS module 111 then updates a list of active communities based on the identification (step 303). For example, the list of active communities includes those communities to which the wireless node 101 belongs (e.g., communities that are private such as a community of personal friends) and those communities that are public and open to all nodes 101 (e.g., a general community of all wireless nodes on the ad hoc network 115 in which system wide messages may be exchanged).

In various embodiments, the AS module 111 is continuously updating the list of active communities by, for instance, monitoring for messaging traffic over the ad hoc network 115 related to one or more of the active communities (step 305). More specifically, the AS module 111 tracks whether there are any messages originating from or directed to one or more of the active communities over a predetermined period of time. In one embodiment, the period of time can be dependent on the on the density or stability of neighboring UEs 101. For example, if the composition of the neighboring UEs 101 is changing rapidly, the time period can be shorter. Similarly, if the composition of the neighboring UEs 101 is more stable, the time period can be longer. In either case, the AS module 111 observes whether there are any messages related to one or more of the active communities (e.g., by checking the header information of the messages for CIDs corresponding to any of the active communities) (step 307). If no messages are observed over the predetermined period of time for a particular community, the AS module 111 designates that community as inactive and updates the list of active communities accordingly (step 309). If a message related to a particular community is observed during the time period, the community is considered to be still active and the AS module 111 need not update the list of active communities. It is contemplated that the awareness services module can continuously or periodically perform the monitoring process to update the list of active communities.

FIG. 3B is a flowchart of a process for passively identifying an active community by monitoring community messages, according to one embodiment. In one embodiment, the AS module 111 performs the process 320 of FIG. 3B and is implemented in, for instance, a chip set including a processor and a memory as shown in FIG. 12. In step 321, the AS module 111 receives a message directed to one or more communities from a neighboring wireless node 101 over the ad hoc network 115. The AS module 111 then determines whether the receiving wireless node 101 is a member of the community to which the message is directed (step 323). For example, the determination may involve checking whether the CID contained in, for instance, the message header of the received message matches a CID contained in the community directory 243 of the receiving wireless node 101. In certain embodiments, the CID is anonymized to protect the privacy of the community and its members. In this case, the receiving wireless node 101 is a member of the community, the AS module 111 may decode the anonymized CID using the authentication key associated with the CID of the community specified in the received message. Further, if the message is encrypted, the AS module 111 may open the encryption using the encryption key associated with the CID as listed in the community directory 243. If the AS module 111 determines that the receiving node 111 is a member of the community (step 325), the module 111 identifies the community as an active community and updates the list of active communities accordingly (step 327).

FIG. 3C is a flowchart of a process for actively searching for one or more active communities using a community search message, according to an exemplary embodiment. In one embodiment, the AS module 111 performs the process 340 of FIG. 3C and is implemented in, for instance, a chip set including a processor and a memory as shown in FIG. 12. In step 341, the AS module 111 receives input requesting a search for one or more active communities in the local neighborhood of the ad hoc network 115. The input is received from, for instance, the application 201 through the application programming interface 225 (as described with respect to FIGS. 2A and 2C). For example, the input may specify one or more communities for which to search. In response, the AS module 111 retrieves a CID for each requested community (step 343). In certain embodiments, the CIDs are anonymized to protect the privacy of the community and its members (step 345). Using anonymized CIDs protects privacy by making it more difficult for an outsider to track communications related to any particular community. The community control module 241 then generates a community search message containing a containing a unique community query identifier CQID and a list of anonymized CIDs (step 347).

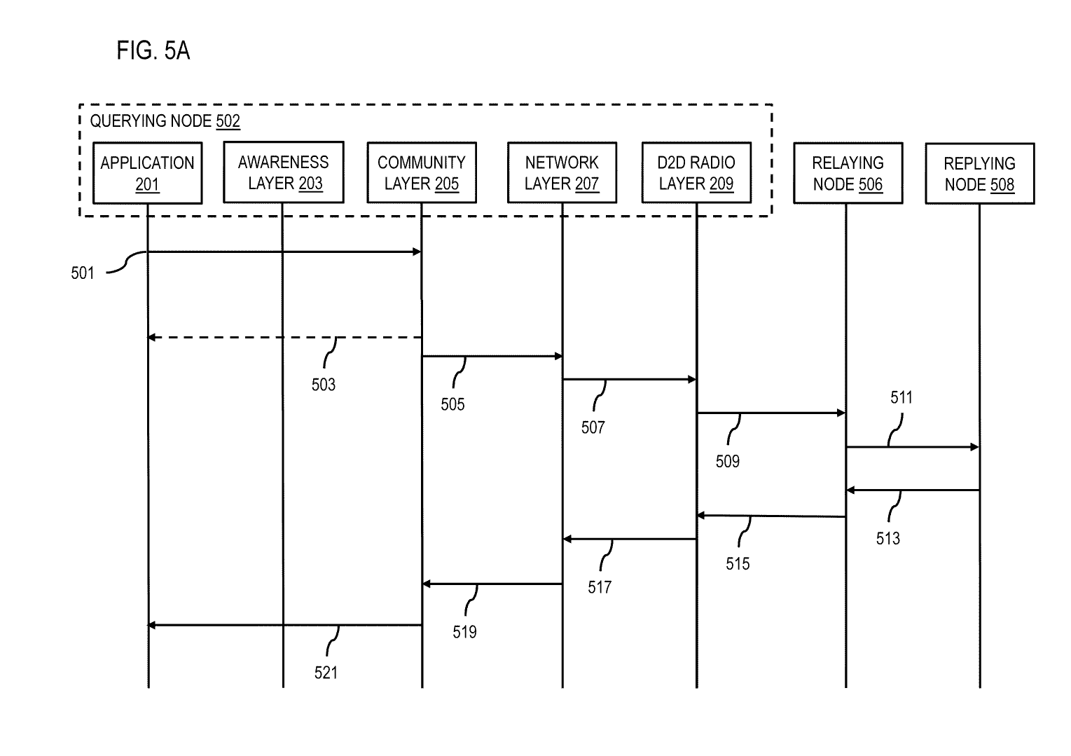

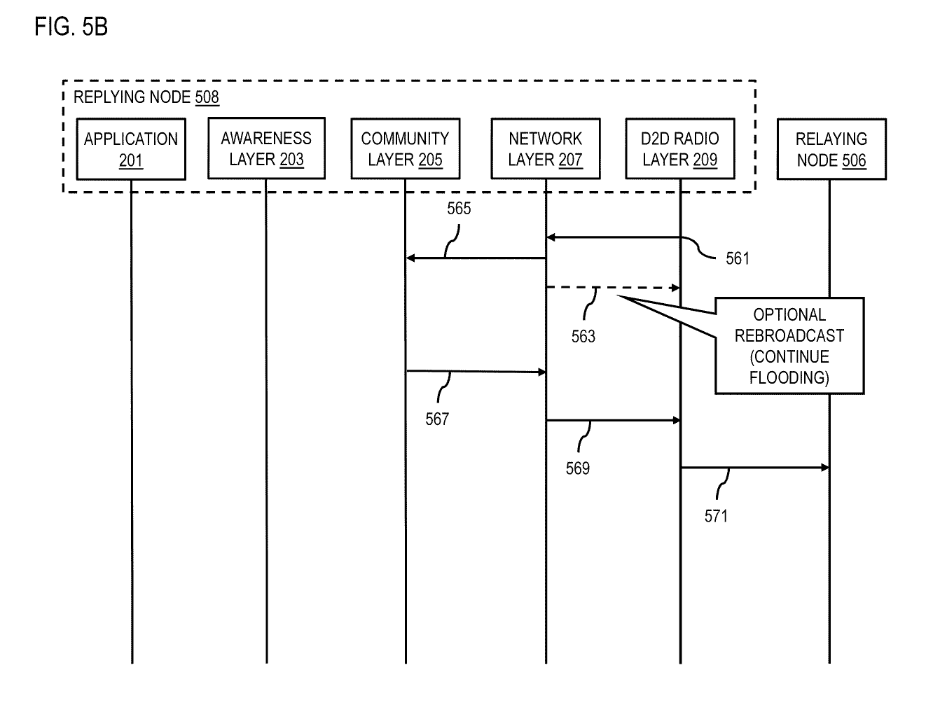

After creating the message, the AS module 111 initiates broadcast of the message over the ad hoc network 115 (step 349). In various embodiments, the community search message is equivalent to a query and is transmitted and replied to using the processes described with respect to FIGS. 5A and 5B below. As the message propagates over the ad hoc network 115, mobile devices that are members of one or more of the active communities associated with the anonymized CID or CIDs included in the message automatically respond to mobile device that originally sent the message. The AS module 111 initiates receipt of the reply messages (step 351). The reply message contains, for instance, a list of anonymized CIDs of those searched communities which have an “active” status in the replying node 101. Based on this list, the AS module 111 identifies each community in the list as an active community and updates the list of active communities in, for instance, the community directory 243 (step 353).

FIG. 3D is a flowchart of a process for actively determining the presence and community-specific identity (e.g., alias) of members of a particular community or communities, according to an exemplary embodiment. In one embodiment, the AS module 111 performs the process 360 of FIG. 3D and is implemented in, for instance, a chip set including a processor and a memory as shown in FIG. 12. In step 361, the AS module 111 receives input requesting a search for one or more members of a community. The input is received from, for instance, the application 201 through the application programming interface 225 (as described with respect to FIGS. 2A and 2C). For example, the input may specify one or more communities whose members are to be searched for. In step 363, the AS module 111 retrieves the CID or CIDs associated with the requested community or communities from the community directory 243. In certain embodiments, the CIDs are anonymized to protect the privacy of the community and its members (step 365). If any one of the communities is set in the “visible” state, the AS module 111 also retrieves the community-specific user identity (e.g., an alias) of the user for that community. By way of example, the encryption/decryption module 245 of the AS module 111 may also encrypt the user alias in step 365 using, for instance, one or more of the keys associated with each community in the community directory 243. The community control module 241 then generates a member search message containing a unique community query identifier CQID, a list of anonymized CIDs, and corresponding plaintext (in case of a public community) or encrypted (in case of a private community) aliases of the members for which to search (step 367).

After the member search message is generated, the AS module 111 initiates broadcast of the member search message over the ad hoc network 115 (step 369). In various embodiments, the member search message is equivalent to a query and is transmitted and replied to using the processes described with respect to FIGS. 5A and 5B below. As the message propagates over the ad hoc network 115, mobile devices that have one or more communities associated with the anonymized CID or CIDs in the “visible” state automatically respond to the mobile device that originally sent the message. If aliases corresponding to one or more users are also included in member search message, mobile devices corresponding to the user aliases also respond. The AS module 111 initiates receipt of the reply messages sent in response to the member search message (step 371). The reply message includes, for instance, a list of anonymized CIDs, plaintext or encrypted user aliases and, possibly, the plaintext or encrypted status (e.g. activity state, mode, etc.) of the community member. In certain embodiments, the AS module 111 uses the reply messages to update the list of visible community members in the local neighborhood (step 373). In addition, the AS module 111 also uses the replies to identify active communities within the neighborhood and to update the list of active communities (step 375). The updates are based, for instance, on the anonymized CIDs, the community-specific member identity (e.g., alias), o other member-specific information included in the reply messages.

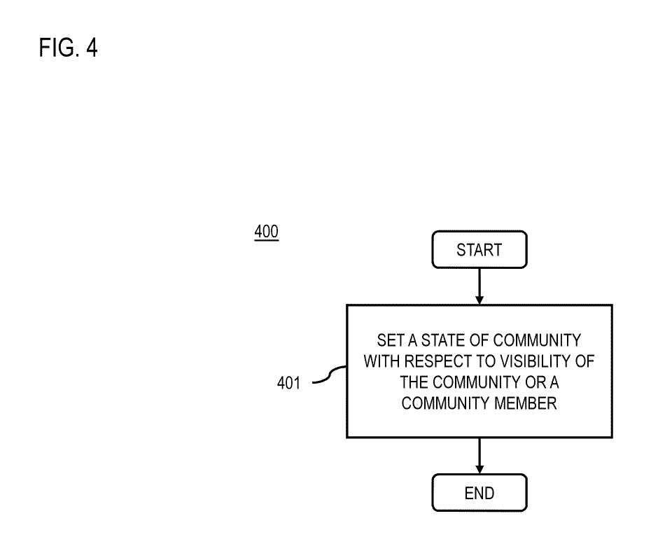

FIG. 4 is a flowchart of a process for setting a state of a community to change the visibility of community or community member, according to an exemplary embodiment. In one embodiment, the AS module 111 performs the process 400 and is implemented in, for instance, a chip set including a processor and a memory as shown in FIG. 12. In step 401, the AS module 111 enables the user to set a state corresponding to a community that determines the visibility of the community or a member of the community. The different states of the community and how the state affects the visibility of status of the community are discussed with respect to FIG. 2D. For example, in various embodiments, when a community is active, it is capable of sending and receiving community specific messages. Similarly, when a community member is visible, the user alias associated with the community member can be queried and sent to other community members.

Moreover, it is contemplated that the state of a community in a wireless node 101 can be used to filter incoming messages. For example, to block all incoming or outgoing messages, a user can set the state of a community to inactive so that all messages from that particular community are disregarded. It is contemplated that a user belonging to multiple communities may independently set the visibility state for each community. By way of example, to block incoming tokens from unrecognized/unaccepted social networking contacts, the user can set the state to inactive for the community sending the tokens. It is also contemplated that the user can automatically set the visibility state based on criteria such as time (e.g., to automatically set a visibility state at certain periods of the day), location (e.g., to automatically set a visibility state at certain locations such as work or school), or any other context (e.g., while in a meeting or based solely on a befriending request).

FIG. 5A is a ladder diagram that illustrates a sequence of messages and processes used in a querying node, according to an exemplary embodiment. A network process is represented by a thin vertical line. A step or message passed from one process to another is represented by horizontal arrows. A dashed horizontal arrow represents an optional step or message. The processes represented in FIG. 5A are the querying node 502, relaying node 506, and replying node 508. Within querying node 502, the following additional processes are represented: application 201, cognition layer 203, community layer 205, network layer 207, and D2D radio layer 209.

In step 501, the application 201 within querying node 502 generates a request for searching community information (e.g., UEs 101 having active communities or communities with visible members) over the ad hoc network 115 and sends the request to the community layer 205 of the querying node 502. For the purpose of illustration, the visibility of members over the ad hoc network 115 is required to further enable the sharing of tokens. The community layer 205 generates a community query message, assigns a community query identification number (CQID) to the query message and prepares the query message for transmission over the ad hoc network 115 by marking the query with CIDs of the communities from which the user is seeking information. If the user seeks information on members of the communities and the communities are private, the community layer 205 encrypts the community-specific user identity (e.g., alias) using the encryption keys associated with the respective CID and stored in the community directory 243 (FIG. 2C). If the community directory 243 contains recent information about active communities in other nodes then the community layer 205 may return the community information (step 503). The community layer 205 then sends the anonymized and partly encrypted message to the network layer 207 (step 505).

The network layer 207 assigns a message sequence number (MID) to the query message and adds fields to the network layer message header 281 (FIG. 2F) to indicate that the querying node 502 is the source and transmitter of the query message (e.g., using the NID). The network layer 207 sends the query message to the D2D radio layer 209 of the querying node 502 for broadcasting in the ad hoc network 115 (step 507).

The query message is then broadcasted to one or more relaying nodes 506 (step 509). All the nodes that are able to receive the broadcast message are relaying nodes. After processing by the relaying node 506, the query message is rebroadcasted to another relaying node or to the replying node 508 (step 511). After processing of the query message by the replying node 508, a reply message is generated and sent to the relaying node 506 (step 513) which routes the reply message either to another relaying node or to the querying node 502 (step 515) based on the route stored in the routing table 273.

At the querying node 502, the D2D radio layer 209 receives and acknowledges the reply message and forwards the reply message to the network layer 207 (step 517). The network layer 207 determines that the querying node 502 is the intended destination of the reply message by checking the DST field 294 in the network layer message header 281 and sends the message to the community layer 205 for processing (step 519). In case of a private community, the community layer 205 decrypts the reply message using the appropriate encryption keys stored in the community directory 243. Based on the information in the reply message, the community layer 205 updates information in the community directory 243 (list of active communities and the lists of visible members in the communities) and finally sends a service response to the query to the application 201 (step 521).

FIG. 5B is a ladder diagram that illustrates a sequence of messages and processes used in a replying node, according to an exemplary embodiment. A network process is represented by a thin vertical line. A step or message passed from one process to another is represented by horizontal arrows. A dashed horizontal arrow represents an optional step or message. The processes represented in FIG. 5B are the replying node 508 and the querying node 502, which for example purposes, may depict an interaction between nodes within the ad hoc network for enabling token exchange. Within replying node 508, the following additional processes are represented: application 201, cognition layer 203, community layer 205, network layer 207, and D2D radio layer 209.

In step 561, the D2D radio layer 209 of the replying node 508 receives the query message and forwards it to the network layer 207 of the replying node 508. The network layer 207 may decide to rebroadcast the query message (step 563). On receipt, the network layer 207 forwards the query message to the community layer 205 (step 565).

If the community layer 205 determines that the query message contains one or more anonymized CIDs of the active communities associated with the replying node 508 and the query message contains encrypted user aliases, the community layer 205 decrypts the message and updates information in its community directory 243 (e.g., containing the list of active communities and the list of visible members of the communities). Next, the community layer 205 generates a reply message that contains the same CQID as the incoming query and has the source NID of the query message set as the destination NID of the reply message. If the query requests visible user aliases and the user alias in the node 508 is set as visible then the community layer 205 encrypts the user alias with the encryption keys associated with the community. The community layer 205 then retrieves a new anonymized CID from the community directory 243 and sends the reply message to the network layer 207 (step 567).

On receipt of the reply message, the network layer 207 assigns a new message sequence number (MSN) to the reply message, attaches the NID of the replying node 508 as the source and transmitter, finds the NID of the relaying node 506 for the next hop from the routing table 263, sets the receive NID of the reply message as the next hop and sends the reply message to the D2D radio layer 209 (step 569). The D2D radio layer 209 sends the reply message as a unicast message addressed to a relaying node 506 over the ad hoc network 115 (step 571).

It is noted that the above described implementations—i.e., for enabling the visibility of wireless nodes (UE 101)—may enable the fulfillment of a proximity condition for promoting token exchange. For example, the detecting of community members (e.g., nodes) may serve as a precursor to enabling the exchange of token information. Hence, the above described exemplary communication procedures for awareness detection may, in certain embodiments, trigger the exchange of tokens accordingly.

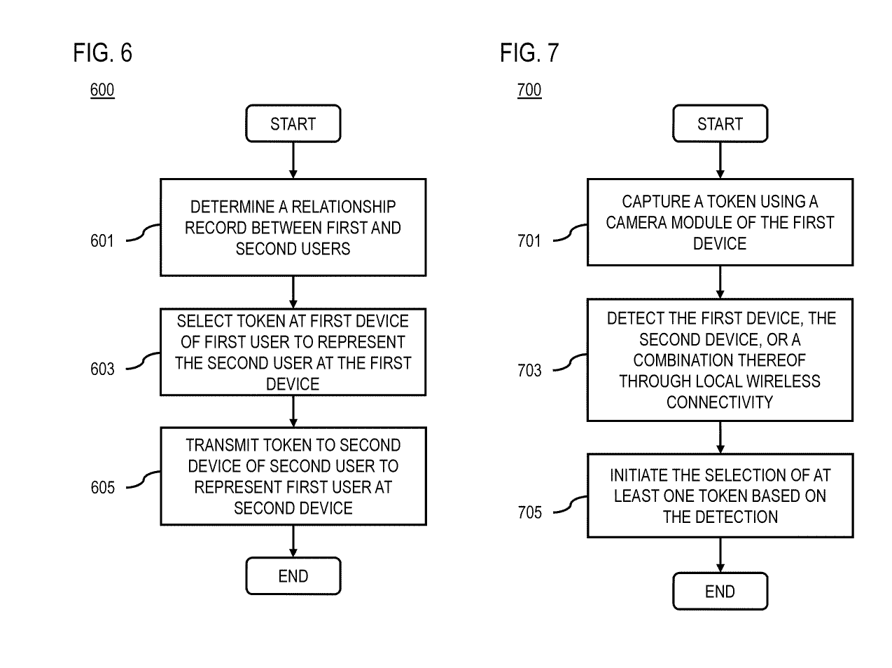

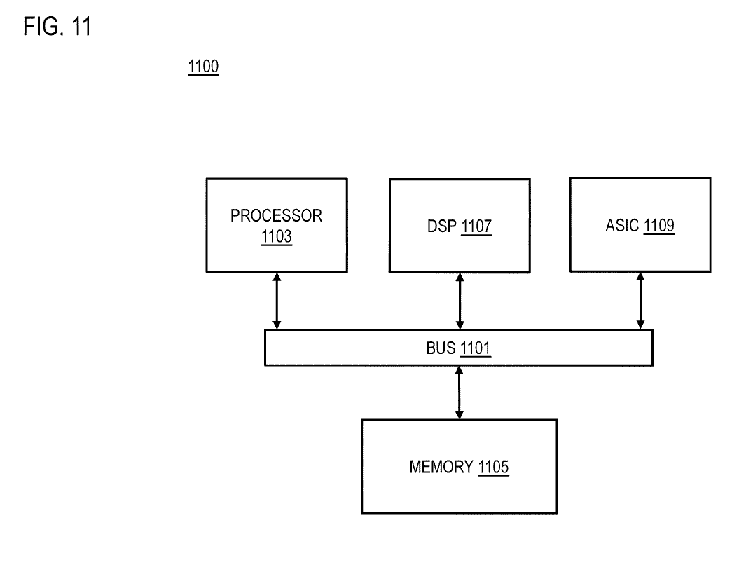

FIGS. 6 and 7 illustrate flowcharts of processes for establishing relationships among devices and users, according to various embodiments. In various embodiments, the token sharing platform 105 may perform processes 600 and 700. For the purpose of illustration, these processes may be implemented in, for instance, a chip set including a processor and a memory as shown in FIG. 11. As such, the AS module 111 can provide means for accomplishing various parts of the process 600 and 700 as well as means for accomplishing other processes in conjunction with other components of the system 100 (e.g., the AS module 111 or token sharing manager 103).

In step 601, the token sharing platform 105 determines that a record indicating a relationship between a first user and at least one second user has been created. As noted previously, the record may correspond to a profile, contact, or other data file for maintaining information regarding the one or more users, including contact information, network location information, alias or network handle information, identifier information, or the like. In another step 603, the token sharing platform 103 selects a token at a first device of the first user to represent the second user at the first device. Per another step 605, the platform 103 transmits the token to the second device of the second user to represent the first user at the second device.

As mentioned previously, the at least one token includes, at least in part, a representation of the first user, the at least one second user, or a combination thereof. Still further, the at least one token represents the first user, the at least one second user, or a combination thereof as an avatar in a contact application, a social networking application, a communication application, or a combination thereof. It is further contemplated that the at least one token may be an executable object, such as a file that is mutually exchanged by or acknowledged by the first and second user. This acknowledgement may occur as a result of an interaction between the first and second user via a service 108 to which both are subscribed (e.g., a social networking service, file sharing service, etc.)

In step 701 of process 700, the token sharing platform 105 captures at least one token using a camera module of the first device. In another step 703, the platform 105 detects the first device, the at least one second device, or a combination thereof through local wireless connectivity. As noted previously, this may include for example, detection means as performed via an ad hoc network 115 or other short-range communication means. The detection determines that the first device and the at least one second device is within a predetermined proximity.

Per step 705, the platform 105 initiates selection of the at least one token based, at least in part, on the detection. As mentioned before, the selection may be based at least in part on a determined association and/or linking of the token with the first and second user in common. Once selected, the at least one token is transmitted to the at least one second device through the location wireless connectivity.

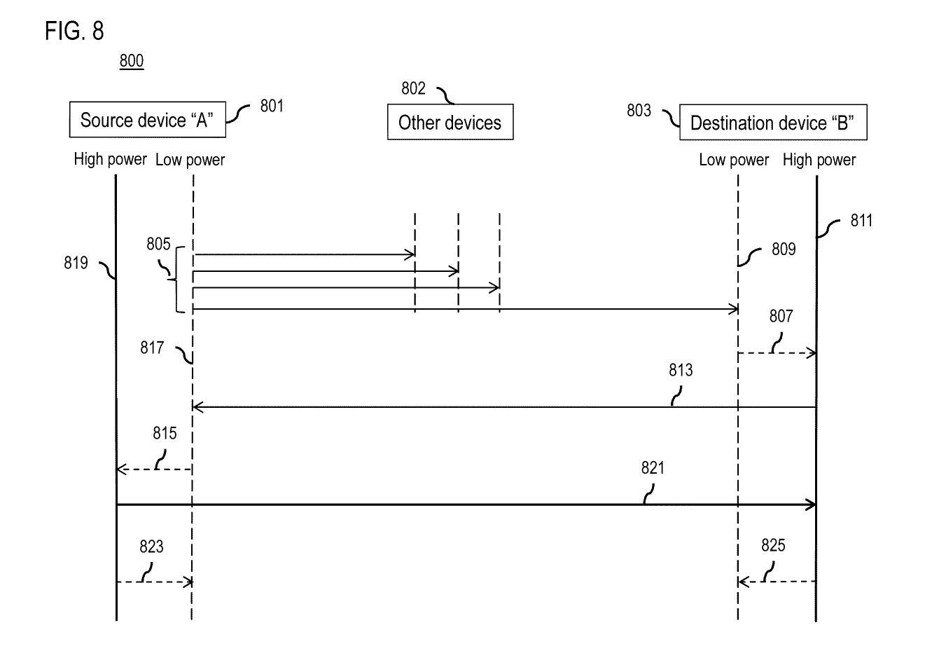

FIG. 8 is a ladder diagram that illustrates sequences of messages and processes used in sharing content via an ad hoc network, according to an embodiment. In one embodiment, diagram 800 shows a plurality of neighboring devices, for example, source device “A” 801 (source device), other devices 802, and destination device “B” 803 (destination device), wherein the plurality of the devices may communicate with each other via one or more communication networks. In one embodiment, the plurality of devices may be members of an ad hoc network, whereby they may share information and content items. In one use case scenario, the source device may broadcast to the other devices 802 and to the destination device awareness information messages 805 which may include a token to be shared. For example, the source device may have an image (e.g., token) to share. In one embodiment, a user of and/or an application at the destination device may review the awareness information messages 805 and the token available for sharing. Further, the destination device, at 807, may switch operating mode from a lower power mode 809 to a higher power mode 811 for sending an awareness message 813 to the source device, which may include various information items, for example, an IP address and a port number of the destination device, a content identifier, and the like. Furthermore, the source device, at 815, may switch from one operating mode (e.g., a lower power) 817 to another operating mode (e.g., a higher power) 819 for establishing a communication channel (e.g., TCP/IP connection) based, at least in part, on the information received via the message 813 from the destination device. At 821, the source device causes a transfer of the generated token to the destination device, whereupon completion of the transfer, the source device may change its operating mode at 823 and the destination device may change its operating mode at 825.

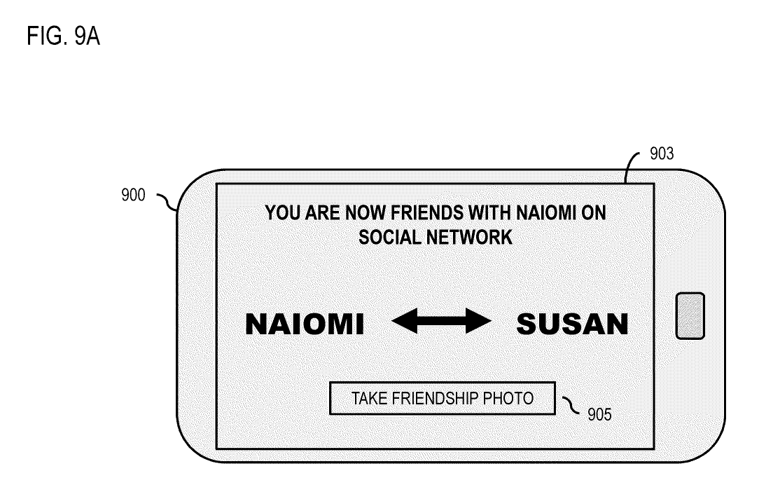

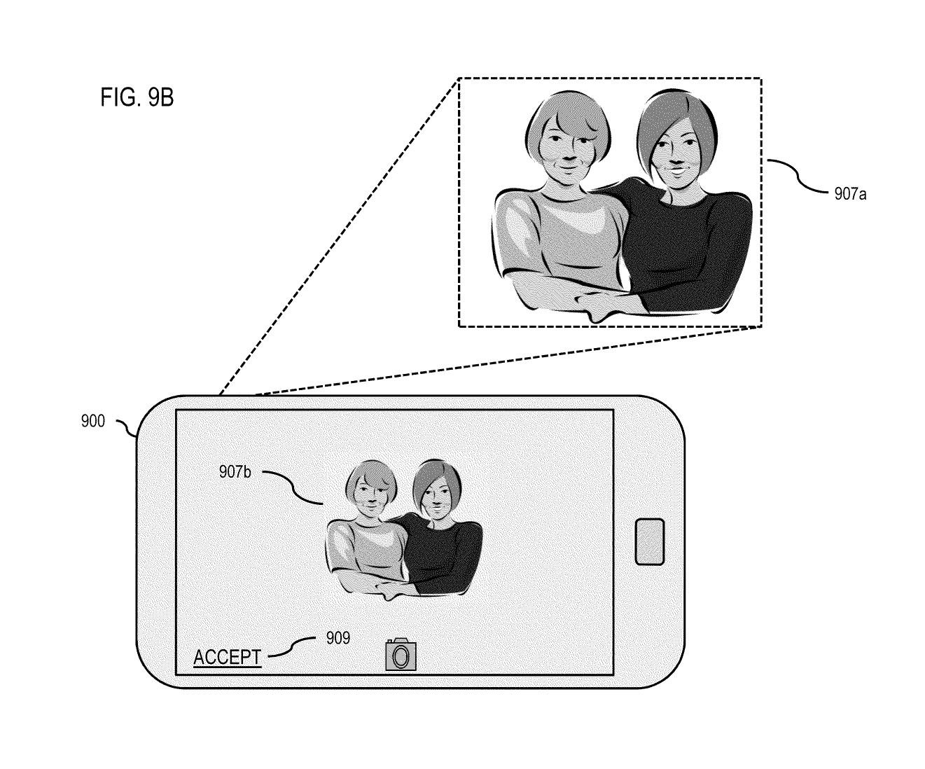

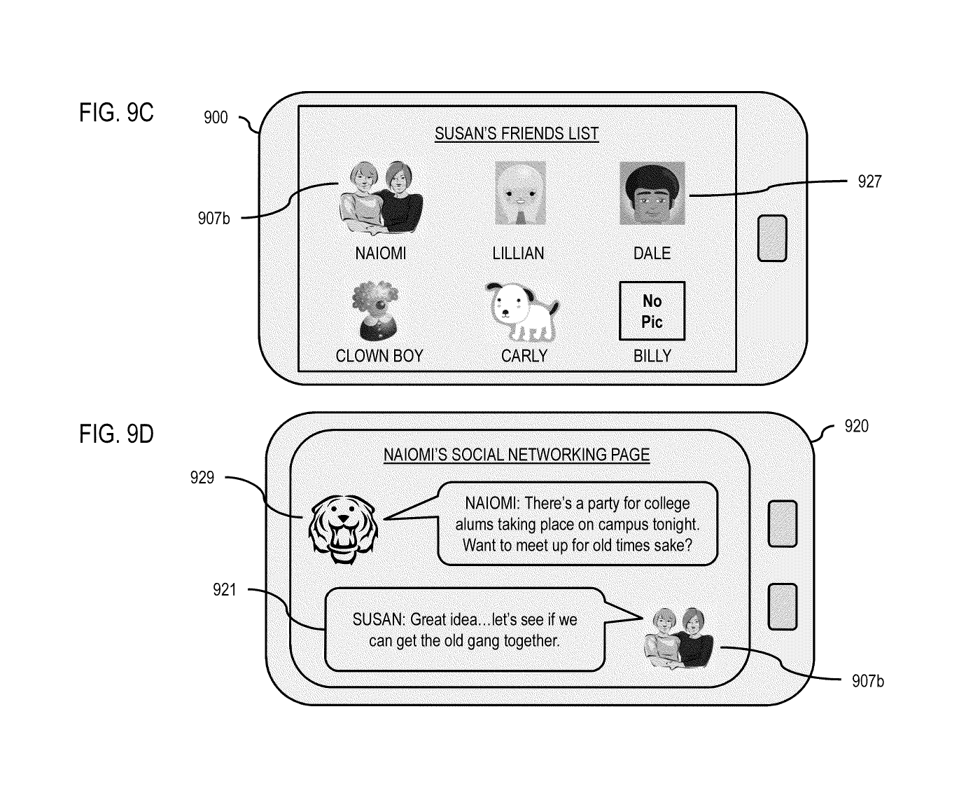

FIGS. 9A through 9D are diagrams of a user interface utilized in the processes of sharing content via an ad hoc network, according to various embodiments. For the purpose of illustration, the diagrams are presented from the perspective of a use case of a user (Susan) of a first user device 1000 interacting with a second user (Naiomi) of a second device via a social networking service (e.g., website). The first user initiates a befriending request with the second user, such as to establish a relationship status between said users per the social networking service 108.

In FIG. 9A, in response to the establishment of the friend relationship (befriending) with Susan, the token sharing platform 103 initiates rendering of a message to a user interface of the social networking service for acquiring and/or generating a token. In this case, this includes presenting a button 905 to the display 903 of the device 900 for activating the camera application of the device 900. It is noted that the rendering of said button 905 to the display 903 may be contingent upon detection of a proximity condition being fulfilled between the first user device 900 and the second user device 920 (FIG. 9D).

In FIG. 9B, the camera application of the user device 900 is activated in response to selection of the button 905. Under this scenario, Susan then positions her user device (e.g., camera ready smart phone 900) to snap a picture of she and Naiomi as they pose (per position 907a) before the camera. This may correspond to a timed image capture function of the device 900. Once the picture/image 907b is captured, Susan is then presented with a link 909 for enabling her to accept the image as being representative of a common token between her and Naiomi. Selection of the link 909 causes the image to be associated with the record for Naiomi and subsequently transmitted to Naiomi's user device 920 (per FIG. 9D).

In FIGS. 9C-9D, having linked and subsequently shared the token (captured image 907b) among the user devices 900 and 920, the image 9007b is shown at the devices accordingly. Under this scenario, for example, Susan's device 900 presents the captured token 907b within a friend list in association with Naiomi. Similarly, Naiomi's device 920 presents the same token 907b with respect to a social networking session in reference to a chat message 921 initiated by Susan. In both instances, a common image 907b is presented to represent the respective users and visually depict their relationship. This is in contrast to a generic or less personable image of the respective users as is commonplace for presenting avatars (e.g., the image of Dale 927).

It is also noted that the avatar 929 for Naiomi is presented at her device 920 in the correct manner, while the image 907b representative of Susan is presented as the shared token. It is contemplated, in future embodiments, that the token sharing platform 105 may be adapted to allow for alterations in the size, shape, shading, or other characteristics of the image for further reflecting a mood, availability or other context/status of the other user.

The processes described herein for establishing relationships among devices and users may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

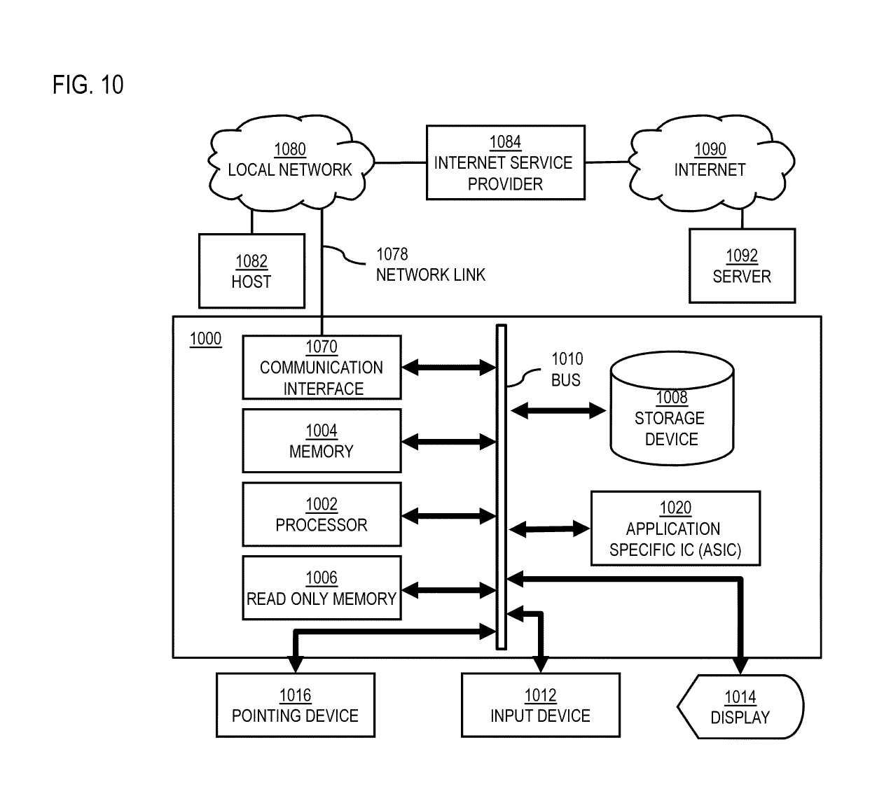

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to share relationship tokens among devices as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of establishing relationships among devices and users.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to share relationship tokens among devices. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for establishing relationships among devices and users. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for establishing relationships among devices and users, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables the computer system 1000 to be connected to the communication network 105.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to share relationship tokens among devices as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of establishing relationships among devices and users.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to share relationship tokens among devices. The memory 1105 also stores the data associated with or generated by the execution of the inventive steps.

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of establishing relationships among devices and users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of establishing relationships among devices and users. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to share relationship tokens among devices. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a selection of at least one token at a first device associated with a first user based, at least in part, on initiating a request to establish and/or modify a record indicating a relationship between the first user and at least one second user, wherein the at least one token represents the at least one second user at the first device; and
a transmission of the at least one token to at least one second device, wherein the at least one second device is associated with the at least one second user and the at least one token represents the first user at the at least one second device.

2. A method of claim 1, wherein the selection of the least one token causes the (1) data and/or (2) information and/or (3) at least one signal to be further based, at least in part, on the following:
a capture of the at least one token using a data capture module of the first device.

3. A method of claim 1, wherein the at least one token includes, at least in part, a representation of the first user, the at least one second user, the record, or a combination thereof.

4. A method of claim 1, wherein the at least one token represents the first user, the at least one second user, or a combination thereof, and wherein the record is associated with a contact application, a social networking application, a communication application, or a combination thereof.

5. A method of claim 1, wherein the (1) data and/or (2) information and/or (3) at least one signal are further based, at least in part, on the following:
a detection of the first device, the at least one second device, or a combination thereof through local wireless connectivity.

6. A method of claim 5, wherein the (1) data and/or (2) information and/or (3) at least one signal are further based, at least in part, on the following:
an initiation of the selection of the at least one token based, at least in part, on the detection.

7. A method of claim 5, wherein the detection determines that the first device and the at least one second device is within a predetermined proximity.

8. A method of claim 5, wherein the at least one token is transmitted to the at least one second device through the location wireless connectivity, and wherein the at least one token is associated with the record based, at least in part, on the selection.

9. A method of claim 5, wherein the local wireless connectivity includes, at least in part, an ad hoc mesh network.

10. A method of claim 1, wherein the at least one token is an image, a video, an audio sample, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a selection of at least one token at a first device associated with a first user based, at least in part, on initiating a request to establish and/or modify a record indicating a relationship between the first user and at least one second user, wherein the at least one token represents the at least one second user at the first device; and
cause, at least in part, a transmission of the at least one token to at least one second device, wherein the at least one second device is associated with the at least one second user and the at least one token represents the first user at the at least one second device.

12. An apparatus of claim 11, wherein the selection of the least one token further causes the apparatus to:
cause, at least in part, a capture of the at least one token using a data capture module of the first device.

13. An apparatus of claim 11, wherein the at least one token includes, at least in part, a representation of the first user, the at least one second user, the record, or a combination thereof.

14. An apparatus of claim 11, wherein the at least one token represents the first user, the at least one second user, or a combination thereof, and wherein the record is associated with a contact application, a social networking application, a communication application, or a combination thereof.

15. An apparatus of claim 11, wherein the apparatus is further caused to:
cause, at least in part, a detection of the first device, the at least one second device, or a combination thereof through local wireless connectivity.

16. An apparatus of claim 15, wherein the apparatus is further caused to:
cause, at least in part, an initiation of the selection of the at least one token based, at least in part, on the detection.

17. An apparatus of claim 15, wherein the detection determines that the first device and the at least one second device is within a predetermined proximity.

18. An apparatus of claim 15, wherein the at least one token is transmitted to the at least one second device through the location wireless connectivity, and wherein the at least one token is associated with the record based, at least in part, on the selection.

19. An apparatus of claim 15, wherein the local wireless connectivity includes, at least in part, an ad hoc mesh network.

20. An apparatus of claim 11, wherein the at least one token is an image, a video, an audio sample, or a combination thereof.

21.-48. (canceled)
